(19) United States
(12) Patent Application Publication
(10) Pub. No.: US 2014/0352462 A1
(43) Pub. Date: Dec. 4, 2014

(54) GYROSCOPIC MOTION MACHINE

(71) Applicant: Walter E. Wood, Sylvester, GA (US)

(72) Inventor: Walter E. Wood, Sylvester, GA (US)

(21) Appl. No.: 13/886,257

(22) Filed: May 2, 2013

Related U.S. Application Data
(60) Provisional application No. 61/641,372, filed on May 2, 2012.

(51) Int. Cl. G01C 19/08; G01C 19/16

(52) U.S. Cl. CPC G01C 19/08; G01C 19/16
USPC 74/5.7

(57) ABSTRACT

A gyroscopic apparatus, having application as prime mover, has a pair, or alternatively multiple pairs, of flywheels disposed opposite one another. A pivot axis of the flywheels lies in a position midway between the flywheels for each pair. Each flywheel has its own separate electric motor or engine. A drive arrangement operates to spin the assembly unit about a second axis, in the same plane, but perpendicular to the flywheel pair axis.

### PRIORITY CLAIM

The present application claims priority and benefit of U.S. Provisional Application No. 61/641,372 filed on May 2, 2012.

### FIELD OF THE INVENTION

The present invention provides a gyroscopic motion machine, in particular a gyro apparatus having application as a prime mover.

### BACKGROUND OF THE INVENTION

Previous efforts have established the use of gyroscopic devices having application as prime movers. U.S. Pat. No. 5,024,112 to Kidd discloses a gyroscopic apparatus as a prime mover, with a pair of discs disposed opposite one another with arms rotatable supporting the discs. The gyro rotation of the two flywheels (only 1 pair of gyro flywheels) is demonstrated by the U.S. Pat. No. 5,024,112. However, the method is very complicated. Both the flywheel and the assembly for rotation is accomplished by belts, gears, and pulleys. A very complicated mechanism does this with a single drive motor. While, the direction of the rotation of the flywheels and the assembly seems to be correct, the mechanism utilizes lever arms for a back and forth motion upon the flywheels, which is suggested to add to the reaction force.

U.S. Pat. No. 5,090,260 provides a gyro motion machine of a different type and provides a different direction of rotation to that which is desirable presently. The '260 gyro is not believed useful for the purposes disclosed herein.

Friction and drag decrease efficiency, and a need exists for a gyro unit that can be used as the prime mover for craft such as autos, trucks, surface type marine crafts, under water marine crafts, aircrafts of all types, man-lifts or working platforms of all types, farm tractors, and space-crafts of all types. A further need exists for a gyro machine that is simple in design, efficient, and easy to scale in several ways for increased reaction force.

### SUMMARY OF THE INVENTION

This new gyroscopic motion machine is distinguished from the existing unit discussed in U.S. Pat. No. 5,024,112. The flywheels for this new proposed unit are directly coupled to motors or engines in the direct vicinity of the flywheel. The flywheels are mounted and rotate inside of a double disk assembly wheel. The electrical power source or fuel is delivered to the flywheel driver motors or engines. For a simple smaller unit, onboard batteries inside the assembly wheel are utilized as the power supply for the gyro flywheel motors, with either batteries or 120 VAC power for the drive motor. For larger electrical units a suitable power source, such as 120 VAC or higher, would be utilized for all motors. The gyro flywheel motor could also be a DC motor type. For engine driven flywheels, a fuel tank could be mounted inside the assembly wheel for a simple unit. Other delivery systems for electrical power or fuel will also be included within this design group and some could be designed at a later date, such as trolley car type delivery systems. Other power systems such as air, vacuum or steam for turbine drives are also included. The gyroscopic motion machine assembly wheel units are additive to provide a choice of multiple gyro motor and flywheel pairs because of the individual component design of the multi-component assembly wheel unit. Each flywheel pair is mounted inside a component section. Several components are assembled into one unit and are driven by a single drive motor unit.

The new proposed gyro motion unit moves horizontally and vertically. It moves with force. No pavement tire traction is required for horizontal movement, nor air movement (propeller or jet) for vertically movement. The force is generated by the rotation of gyro flywheels within a disk assembly. First the flywheel pairs are started spinning at a constant speed for the potential gyro energy, which is then rotated as a unit assembly (“gyro assembly wheel unit”) for a reaction force that produces motion. The resistance of the unit assembly to this rotation is proportional to the amount of stored rotational energy of the gyro flywheels and the rotational speed of the gyro assembly wheel unit. This resistance to the turning of the unit assembly produces a reaction force.

The gyro flywheels are individually rotated by either electric motors or engine type motors. The gyro flywheels are mounted in a double disk type “gyro assembly wheel unit”. Other shapes such as ovals can be used for the assembly unit sides. A simple containment of the gyro flywheels and bearings, with a shaft completes the unit assembly.

Motor drivers (either electric or fuel type engines) drive each flywheel. The diametrical design requires that each flywheel pair has one counter clockwise flywheel and one clockwise flywheel for the reaction force to occur, positioned exactly opposite or 180 degrees apart. Fuel unit and electric driven flywheels will be reversed in rotational direction. The electrical leads would be reversed for a DC motor. Engines would be rotationally opposite each other on start up. This is possible for small and simple model engines. (Larger 2 cycle UAV engines can be ordered and purchased CCW or CW for the larger sizes.) This allows a perfectly balanced, symmetrical and diametrical design for the gyro assembly flywheel pairs. For the pair, the flywheels and motors are required to be diametrical. Larger engines can be built that would run in either direction clockwise or counter clockwise, and are expected to be 2 cycle type engines. The 2 cycles are lighter weight also. A pulley and belt, gear to gear, or chain and sprocket system can be utilized for the assembly wheel unit drive. Gear drives will require oiling and housing with seals for good machine life. Therefore an off the shelf gear motor set can be used for the assembly wheel unit drive. All of these methods for the drive system are claimed by this document, even though only the pulley and belt drive system is shown completely. A simple conversion is an obviously variation.

The assembly wheel unit is rotated by another electric motor or engine. One assembly wheel unit, with a pair of gyro flywheels mounted inside, and a craft frame is a simple complete unit for motion.

This unit is additive for multiple gyro flywheel pairs due to the individual component design of the assembly wheel. The positions of the gyro flywheel pairs can be made in two ways. One is done by rows and another way is by simply making the assembly disk wheel larger for more room for gyros motors and flywheels. Both cases provide equal spacing and are symmetrical in design. Also the gyro motors and flywheel pairs are diametrical.

Multiple pairs can be utilized to increase the total reaction force. For multiple pairs of gyro flywheels, a stacked row arrangement can be used for a normal size gyro disk wheel. A special and sequential order is required for the rotational positions. Another very good arrangement is for all the gyro flywheel pairs to be lined up for multiple rows in the gyro assemble wheel unit. Again the gyro motors and flywheel pairs are diametrical.

For multiple sets of gyro flywheel pairs, another arrangement is equal spacing in an angular placement of the gyros within the gyro assembly wheel. Therefore a larger disk for the assembly wheel is required. Again the gyro motors and flywheel pairs are diametrical.

In all the above cases with multiple additional gyro pairs mounted in a unit assembly, the assembly unit has a single drive motor system including one motor, one shaft, one set of drive pulleys, etc.

For the assembly wheel, the maximum precession speed must not be exceeded; or a pulse force will be the result, with only a partial reaction force (a percentage). This could be expressed as a time duration effect, and a percentage factor would need to be applied to compensate for the pulse force. Therefore, the drive speed of the assembly wheel will be kept slow enough for a 100% reaction force, and is critical for the best performance. Thus the reaction force is continual, without pulsing. Of course, this applies to the drive motor unit or the third motor unit. It could be a gear motor or a standard motor, with additional gear down provided. In addition a vfd (variable frequency drive) speed controller could be provided on the slow side. The drive speed can be controlled from zero to the maximum, which is the precession speed. Therefore, the resultant reaction force can be modulated by optimizing the rpm (revolutions per minute) speed of the drive motor unit.

It is important for a reasonable and uniform force direction to make all the gyro flywheels the same exact speed to minimize complications; this creates a balanced reaction force. For a symmetrical, diametrical, and balanced arrangement, the resultant force is at the exact center of the assembly wheel disk, and is perfectly perpendicular to the disk for each assembly wheel unit. The resultant force is parallel with the gyro assembly unit shaft and for a perfectly constructed unit is located in the exact center of the shaft and would be transmitted through the thrust component of the gyro assembly wheel bearings to the frame of the unit. The resultant force obeys a right handed rule for the direction. (When the fingers of the right hand curl and point in the direction of the assembly wheel rotation, then the thumb points in the direction of the force.)

There are two ways to deliver the input power (the power to spin both the flywheels inside the gyro assembly.) The first way is for the unit to have its fuel or batteries mounted inside the gyro assembly wheel unit. (Batteries were used on a small working model.) Then a simple supply of power is an easy transfer. The second way is for the unit to have an electric power cord or a fuel line, either for electric motors or a combustion engines. Some special fittings are required to deliver the fuel or electric power to the gyro flywheel driver (motor or engine) when the assembly wheel unit is rotating.

Bronze washer like rings for electrical current delivery are required for utilizing typical motor type brushes. One outer ring and one inner ring would be mounted on one disk. Two different size rings and separation is required. Alternately one ring of the same size diameter could be mounted on the two disks, one on each end.

A swivel joint could allow a supply fuel to be piped into the assembly wheel. A fuel delivery system can be utilized by using a swivel joint on the disk to allow the fuel to be delivered to the engine. A hollow shaft permits delivery to the inside of assembly wheel for distribution. On the outside of the shaft a swivel joint makes connection to the fuel lines for a supply and return type piping system. Two swivel joints are required, one on each end.

For ground units normal steering can be utilized, such as turning the front tires and a normal steering wheel system, but also directional gyro forces are possible. This is done by turning the gyro assembly in a specific direction and coordinating with the vehicle front wheels. (Either by turning the front wheels simultaneously or allowing them to be free to turn and follow the direction of the gyro, or possibly even the rear tires to turn free with the front tires set straight.) By applying very good directional controls the dangers of snow and ice travel should almost be totally eliminated, since traction could become much less of an issue. Forward and directional motion would be controlled for an exact position and not dependent on traction of the tires. Normal wheel type brakes would be a backup system only, since reversing the gyro assembly would very effectively apply breaks, by applying an opposite force. The forward and reverse forces can also be modulated up or down, by the speed of the gyro assembly wheel unit. There is going to be a slight delay to stop and reverse the gyro assembly wheel unit and to get the unit rotating in the opposite rotational direction to apply a breaking or reverse force to the vehicle or craft. There is no correlation of gyro and vehicle and its tire speed. A simple force is applied for acceleration of the vehicle and is related to the gyro assembly wheel speed. The force has it's magnitude without correlation to vehicle speed. For coasting the gyro assembly wheel unit is stopped. Therefore, no force is applied.

For special units, such as man lift units, special cart wheels could be utilized for better maneuverability. All four wheels would turn when the gyro assembly turned and the directional force applied, the cart would move sideways. The cart wheels could possibly be freewheeling for easy turning. VTOL (vertical takeoff and landing) units are shown, but the man lifts may require special designs.

This unit can be used in aircraft either as a vertical takeoff and landing craft “VTOL”, or a normal winged aircraft. For VTOL crafts multiple gyro units would be used for cargo aircrafts. Cargo platforms will typically utilize four gyro units for lift, and one for horizontal motion. Very special controls can be developed to change each of the gyro speeds for a stable flight. For increase in altitude the speed for the vertically gyro assembly unit would be increased. Likewise a decrease below the balance point would allow gravity to descend the craft.

A ballast system with pumps and water tanks could also be utilized. A track and gear bar can be utilized for a moving ballast system. The system would move ballast weights or move the gyro units themselves. System variations include the above track and gear bar, a chain and sprocket system, a screw gear or a cable and reel system. (See FIGS. 22, 23, 24, 31 and 36.) In addition to a mechanized moving system could be a tank and pump systems for ballast control, which are included. Even a swivel mounting system for the lifting gyro units is included. Extensive control systems with sensors are required.

For the normal winged aircraft units, only horizontal gyro assembly wheel units would be used. The aircraft would utilize normal steering such as a tail for up and down control, rudder for turning left or right, and ailerons for turning with embankment. Gyro assembly wheel units would work for the forward push in lieu of the normal propellers or jet engines. The force would be direct without moving air, and would be much more efficient.

Special military units could be designed, similar to the jump jets, which use deflectors to push air down. This can be done by turning the gyro assembly in a certain direction. The gyro assembly could be mounted so it would swivel, and therefore the forces could be rotated.

Starting with a vertical force for lift off, and moving horizontally for ordinary flight. Very careful control for the transition would be required. Only a single gyro assembly would be required for the normal flight and for VTOL (vertical takeoff or landing craft).

Due to the inherent nature of this unit, there could be several smaller units for special purposes such as stabilizing for torsion, etc. The total weight is very important in all of the designs. Air born units for military purposes will require addition gyro units most likely.

Bearing members, such as rollers may be added on the outside edge of the flywheels and are included in this design group that restrain excessive wobble. Roller arrangements include the flywheel rollers with outside sleeves, and other variations. These additional parts act as bearings to prevent excessive movement of the weighty flywheels when the assembly wheel speed is changed or stopped and reversed. These include two types of rollers; flat roller and spherical rollers. A special trough is used as a guide with the spherical rollers. A regular sleeve would be used for the flat roller. Also special skid knobs with sleeves are included. Rollers could be made of rubber or hard plastic, nylon, or even steel. In addition, outside bearings have been included to do the same function with or without a coupling to the motor shaft. (Depends on the motor shaft length.) Similarly, separate outside bearings are included for units with flywheels on a single shaft. These last two are equal in merit in regards to stability, but are very different designs.

In lieu of the above rollers and guides, magnetic bearings can be utilized. They provide air gaps for complete friction free rotation, but also could prevent wobble when a larger size is used. They can also be provided in lieu of the regular bearings and are fitted to match the shaft diameter. They can also be used to replace the normal bearings on the gyro assembly wheel unit. They are available for thrust also, and can be utilized on each end the assembly wheel unit and for the flywheel if needed.

A merit of a magnetic coupling is that the resultant rpm speed can be controlled. Therefore when utilized, the force can be modulated for the unit with speed control for the gyro assembly wheel unit.

For flywheel rotations there are optional methods to power it. A vacuum could be utilized with a turbine wheel on each flywheel. Similarly an air turbine system could be utilized, where air compressors provide pressurized air. Only a supply line swivel joint connection is needed for vacuum and pressurized air systems. Similarly a steam turbine system could be used, very similar to a normal steam turbine. All these would require a specialized fitting connection to the gyro assembly from the tanks and pumps, which are mounted on the exterior framing. A swivel joint is a fitting that allows swivel on one side of the supply line. The swivel joint is typically connected to a hollow shaft. The swivel joint fittings could also be used for the turbine supply or return piping. In addition, it could be used for supply and return for a hydraulic type motors.

For a shift in the resultant force direction (to turn the gyro reaction force to a different direction) the gyro assembly could be mounted on a swivel to allow a rotation. (A maximum of 180 degrees is practical and possible.) With a reversing motor for the assembly, a reverse force would allow complete directional flexibility in combination with above for a 360 degree directional reaction force. (A 180 degree rotation is required for the gyro unit.) The mechanism to turn the assembly could be motorized or turned by hand. This could be utilized for ground, air born, or marine units.

For light weight construction, an alternate construction for the gyro flywheel is normal spokes and rim wheels with normal connection to the motor shaft. Flywheel weights will be attached to the rim. Also, the flywheel disk type could be drilled with large and small holes to minimize the interior weight of the flywheel. (Weight for the gyros flywheel should always be applied to the outer part of the flywheel.) These are obvious engineering principles for flywheel and angular momentum equations for factors such as radius of gyration, etc. However the designs and claims are included for this unit for the maximum reaction force due to the gyroscopic resistance. Therefore these designs cover this principle.

Engine driven flywheels can be used as an alternate. On board fuel tanks could be used, mounted inside the assembly wheel. The position could be 90 and 270 degrees staggered away from the gyro flywheels to help with the dynamic balancing. The endurance of the bearings for the assembly would be improved, wherein a more even distribution of weight is placed around the disk.

A VFD (Variable Frequency Drive) controller would be used to change the speed of the driver motor units for the gyro assembly wheel. For VTOL units, altitude and tilting sensors would be utilized and/or developed. These would be used in connection with the VFD controller. The controller would change each gyro assembly drive motor, in accordance with settings, etc. A pilot would input the desired directions. An alternate is a magnetic coupling used between two shafts that drive the assembly wheel. In both cases the drive motor could be reversed for a reversed directional reaction force.

For horizontal units, some embankment for turning could be incorporated utilizing banking control on each side, such as a controller with adjusting lifters or shocks on each side. In another object of the invention, stabilizer type gyro units could be utilized for truck trailer overturning prevention. (See FIG. 35.)

An object of the present mechanical gyro unit is to provide an energy input that is nearly equal to the energy out, with only a slight bearing loss for friction. Therefore, almost all resistance is converted into a useable reaction force. The resistance of rotation is due to the energized gyro flywheels. The force would be a pure reaction force. Therefore, there is no need for a propeller to move air, or tires to grab the road. But instead a pure resultant force is produced by the unit, on the framing, at the center of the assembly wheel disk at the thrust bearings.

Another object of the invention is to improve the movement of automobiles. All existing automobiles are somewhat inefficient since they depend on friction at the tires. This new unit does not, and therefore it is much more efficient. The reaction force is direct forward, parallel with the vehicle, and does not depend on traction with the road paving, etc. The only inefficiency is the friction in the bearings and road friction, etc. Forward motion would have a normal air drag depending on the shape of the unit. The result expected is almost 100% efficiency for this new gyro assembly wheel unit.

Yet another object of the invention is to improve efficiency of aircraft. All existing aircrafts units are very inefficient, due to moving air for the thrust for all air craft. This new unit is close to 100% efficient. Forward motion would have normal air drag depending on the shape of the unit. Forward motion will have a very high efficiency and only friction or drag would hinder the forward motion. Both drag and friction are expected to be minimal.

Another object is to use the present gyro unit with an external power system. A well designed electric power and/or fuel delivery systems such as trolley car type power rail systems, could be used for all the crafts.

Still another object is to use on-board fuel delivery and storage tank systems for engine driven units. Some units could utilize small generators to allow some of the gyro unit motors to remain electric.

Another object would be to provide a machine for a gyroscopic motion propulsion system for deep space travel. No jet propulsion and likewise no discharges are required.

External bearings outside the flywheel would allow additional flywheel weight and would allow a larger flywheel diameter and would prevent wobble or out of place positioning. (See FIG. 34)

For flywheel repositioning inside an assembly wheel, a screw type mechanism could be utilized. (See FIGS. 29A, 29B, 29C, 37A and 37B.)

A combo engine with fuel tanks, dc generator, and dc electric motor driven flywheels can be utilized (See FIG. 40.) The engine could be off the shelf UAV (Unmanned Aerial Vehicle) engine unit, or custom built for the larger sizes. The UAV engines are generally two cycle type engines. A magnetic type coupling could be utilized. (See FIG. 41.)

A rubber wheel drive system, similar to an older snapper mower type drive system, could be utilized for the assembly wheel drive system. This could be utilized for small gyro assemblies. The rubber drive wheel would be positioned onto the disk assembly by pressure with a spring mechanism. The exact position could be adjusted to a more outer radius for more gear down or to an inner radius for a higher speed. An alternate and more powerful frame mounted motor is also shown for the rubber wheel drive that allows a solenoid to turn the unit on and off by engaging the rubber wheel with a lever. The radius position can be reset manually, but can be made automatic by a splined shaft and other lever mechanisms for a motorized movement for speed control on the fly. This would be an obvious improvement from what is shown in the figures. What is shown is a manually speed adjustment design, where the position of both the motor and the rubber wheel is moved manually and equally. (See FIGS. 28 and 38.)

### BRIEF DESCRIPTION OF THE FIGURES

FIG. 1 ISOMETRIC (GYRO CARTS) is an isometric view of an illustrative gyroscopic motion machine in accordance with an embodiment of the present invention. DETAIL A is an enlarged end view of a flywheel of the machine. DETAIL B is an enlarged isometric view to show the gyro assembly internal components. DETAIL C is an enlarged isometric view to show the motor's mounting clamp. SECTION A (PARTIAL) is an enlarged sectional view of a flywheel and shaft assembly of the machine in DETAIL A.

FIG. 2 ISOMETRIC (GYRO CARTS) is an isometric view of one embodiment of a steering mechanism connected to a gyroscopic motion machine. DETAIL A is an enlarged isometric view to show the motor's mounting clamp. DETAIL B is an enlarged isometric view to show the steering pulley and the steering motor. DETAIL C is an isometric view to show a lift block.

FIG. 3 ISOMETRIC (ASSEMBLY WHEEL COMPONENT) is an isometric view of an alternative configuration of the gyroscopic motion machine in accordance with the invention. SECTION A is a cut-away end view along line A illustrating the alternative arrangement of flywheel pairs. DETAIL A is an enlarged isometric view to show the motor's mounting clamp.

FIG. 4 END VIEW (ASSEMBLY WHEEL UNIT) is a front view of a disk of an assembly wheel for electrical current delivery inside the component used in the gyro motion machine. SECTION A (PARTIAL) is a cut-away view along line A.

FIG. 5 END VIEW (ASSEMBLY WHEEL UNIT) is an end view of the assembly wheel of the illustrative gyroscopic motion machine showing a swivel joint and hollow shaft mechanism for the delivery of fuel. SECTION A (PARTIAL) is a cut-away view along line A.

FIG. 6 END VIEW SECTION WITH ENGINES AND FUEL TANKS (ASSEMBLY WHEEL COMPONENT) is an end view illustrative of an alternative flywheel drive system with glow plug type engines arranged with respect to an assembly wheel used in the gyro motion machine.

FIG. 7 END VIEW TURBINE DRIVEN FLYWHEEL (ASSEMBLY WHEEL COMPONENT) is an end view illustrative of an alternative turbine drive flywheel used in the gyroscopic motion machine. SECTION A is a cut-away view along line A. SECTION B is a cut-away view along line B.

FIG. 8 END VIEW (FLYWHEEL) is an end view illustrative of a flywheel design with accessories to prevent wobble used in the gyro motion machine. SECTION A is a cut-away view along line A. SECTION B is a cut-away view along line B. DETAIL A is an enlarged sectional view to show the roller.

FIG. 9 END VIEW (FLYWHEEL) is an end view illustrative of a flywheel design with accessories to improve stability. SECTION A is a cut-away view along line A. SECTION B is a cut-away view along line B. DETAIL A (SPHERICAL ROLLER) is an enlarged end view of a roller riding in the curved trough.

FIG. 10 ISOMETRIC (ASSEMBLY WHEEL COMPONENT) is an isometric view illustrative of an alternative assembly with one electric motor for a pair of flywheels in the gyroscopic motion machine. SECTION A is a cut-away view along line A. DETAIL A is an enlarged isometric view to show the motor's mounting clamp.

FIG. 11 ISOMETRIC (ASSEMBLY WHEEL COMPONENT) is an isometric view illustrative of an alternative assembly with one electric motor for a pair of flywheels of the gyroscopic motion machine. SECTION A is a cut-away view along line A. SECTION B is a cut-away view along line B. DETAIL A is an enlarged isometric view to show the motor's mounting clamp.

FIG. 12 ISOMETRIC (GYRO CART) is an isometric view illustrative of an alternative embodiment of a gyroscopic motion machine with magnetic coupling. DETAIL A is an enlarged isometric view to show the motor's mounting clamp.

FIG. 13 ISOMETRIC (GYRO UNIT) is a plan view of a flywheel with magnetic external bearings illustrative of an alternative embodiment. DETAIL A is an enlarged isometric view to show the motor's mounting clamp.

FIG. 14 ISOMETRIC (VTOL GYRO CRAFT) is an isometric view of vertical lift gyroscopic motion machines mounted on an illustrative platform in accordance with an embodiment of the invention. DETAIL A is an enlarged isometric view to show the motor's mounting clamp. DETAIL B is an isometric view to show a lift block.

FIG. 15 ISOMETRIC (VTOL GYRO CRAFT) is an isometric view of an illustrative platform for the gyroscopic motion machine in an alternative embodiment including a stabilizer gyro wheel assembly unit. DETAIL A is an enlarged isometric view of the stabilizer gyro wheel assembly unit. DETAIL B is an enlarged isometric view to show the motor's mounting clamp.

FIG. 16 BALLAST WATER TANKS (VTOL GYRO CRAFT) is an isometric view of an illustrative platform for the gyroscopic motion machine in an alternative embodiment including a ballast water tank system for level flight.

FIG. 17 PIPING AND FLOW DIAGRAM is a schematic view of the pump system for the ballast water tank system of FIG. 16.

FIG. 18 ISOMETRIC (VTOL GYRO CRAFT) is an isometric view of a vertical lift gyro assembly illustrative of an alternative embodiment with a swivel mounting arrangement. SECTION A (PARTIAL) is a cut-away view along line A. DETAIL A is an enlarged isometric view to show the motor's mounting clamp. DETAIL B is an isometric view to show a lift block.

FIG. 19 END VIEW (FLYWHEEL) is an end view illustrative of an alternative embodiment of a flywheel used in the gyroscopic motion machine. SECTION A is a cut-away view along line A.

FIG. 20 END VIEW (FLYWHEEL) is an end view illustrative of an alternative embodiment of a flywheel used in the gyroscopic motion machine. SECTION A is a cut-away view along line A.

FIG. 21 END VIEW (FLYWHEEL) is an end view illustrative of another alternate flywheel design with accessories to prevent wobble used in the gyroscopic motion machine.

FIG. 22 ISOMETRIC (VTOL GYRO CRAFT) is an isometric view of a vertical lift gyro assembly illustrative of an alternative embodiment in which the vertical lift gyro assembly can be repositioned with reversible motor. DETAIL A is an enlarged isometric view to show the motor's mounting clamp. DETAIL B is an enlarged isometric view to show the limit switch. DETAIL C is an isometric view to show a lift block.

FIG. 23 ISOMETRIC (VTOL GYRO CRAFT) is an isometric view of a vertical lift gyro assembly illustrative of an alternative embodiment for repositioning the vertical lift gyro assembly with reversible motor. DETAIL A is an enlarged isometric view to show the motor's mounting clamp. DETAIL B is an enlarged isometric view to show the limit switch. DETAIL C is an enlarged isometric view to show a typical corner sprocket and chain. DETAIL D is an isometric view to show a lift block.

FIG. 24 ISOMETRIC (VTOL GYRO CRAFT) is an isometric view of a vertical lift gyro assembly illustrative of another alternative embodiment for reposition the gyro assembly with reversible motor. DETAIL A is an enlarged isometric view to show the motor's mounting clamp. DETAIL B is an enlarged isometric view to show the motor, drive gear and bar gear. DETAIL C is an isometric view to show the limit switch. DETAIL D is an isometric view to show a lift block.

FIG. 25 SIDE VIEW (GEAR DRIVE) is a side view for a gear arrangement for turning a gyroscopic unit of a gyroscopic motion machine for changing directional movement.

FIG. 26 SECTION AND END VIEW WITH ENGINE (ASSEMBLY WHEEL COMPONENT) is a end view of an alternative assembly of a double ended engine driver for a pair of flywheels in the gyroscopic motion machine that is an alternative to the driver shown in FIG. 10.

FIG. 27 ISOMETRIC FISH LINE FLYWHEEL is an isometric view of an alternative flywheel configuration for a gyroscopic unit.

FIG. 28 ISOMETRIC (GYRO CART) is an isometric view of an alternative gyroscopic motion machine in accordance with the invention with rubber wheel drives for the disk assembly wheel used for smaller applications. DETAIL A is an enlarged isometric view to show the motor's mounting clamp.

FIGS. 29A, B, & C are a group of isometrics, sections and details for the variable radius gyro flywheel position type unit. FIG. 29A ISOMETRIC (ASSEMBLY WHEEL COMPONENT) is an isometric view of an alternative gyroscopic unit of the gyroscopic motion machine arranged according to an embodiment for movement of the flywheels and the motor to manipulate the reaction force of the unit. SECTION A (FIG. 29A) is a cut-away view along line A (FIG. 29A) showing a position of the flywheels and motor. SECTION B (FIG. 29B) is a cut-away view along line B (FIG. 29A) showing a position of the flywheels and motor. FIG. 29C SECTION A (ALTERNATE MOTOR LOCATION) is a cut-away view along line A (FIG. 29A) showing a position of the flywheels and an alternative motor position. DETAIL A (FIG. 29A) is an enlarged isometric view to show the limit switch. DETAIL B (FIG. 29C) is an enlarged isometric view to show the motor's mounting clamp.

FIG. 30 DC ELECTRIC SCHEMATIC is a schematic wiring diagram for an 18 DC volt system for a toy model assembly wheel and cart unit using the gyroscopic motion machine of the invention.

FIG. 31 ISOMETRIC (VTOL GYRO CRAFT) is an isometric view of an alternate illustrative embodiment featuring an alternative reel drive unit for manipulating the position of the gyro unit with reversible motor. DETAIL A is an enlarged isometric view to show the motor's mounting clamp. DETAIL B is an enlarged isometric view to show the limit switch. DETAIL C is an enlarged view of the idler pulley. DETAIL D is an isometric view to show a lift block.

FIG. 32 ISOMETRIC (GYRO UNIT) is an isometric view of a gyroscopic assembly wheel unit of a machine in accordance with an embodiment of the invention including additional weights offset from the location of the flywheels. DETAIL A is an enlarged isometric view to show the motor's mounting clamp.

FIG. 33 ISOMETRIC (VTOL GYRO CRAFT) is an isometric view of a combination of multiple components mounted together forming a single unit in a gyroscopic motion machine illustrative of an embodiment of the present invention. DETAIL A is an enlarged isometric view to show the motor's mounting clamp. DETAIL B is an isometric view to show a lift block.

FIG. 34 ISOMETRIC (GYRO UNIT) is an isometric view of a gyroscopic assembly wheel unit of a machine in accordance with an embodiment of the invention including additional bearings and shaft couplings for maintaining a stabilized flywheel position for starting and stopping of the gyro assembly wheel unit. DETAIL A is an enlarged isometric view to show the motor's mounting clamp.

FIG. 35 (GYRO STABILIZER) is an isometric view of truck trailer mounted gyro stabilizer units for the prevention of overturning during high speed turns. The gyro assembly drive motors will be reversible to provide left or right turn assistance for the tall and loaded trailer. DETAIL A: (GYRO STABILIZER) is an enlarged isometric view to show the gyro assembly internal components. DETAIL B is an enlarged isometric view to show the motor's mounting clamp.

FIG. 36 ISOMETRIC (VTOL GYRO CRAFT) is an isometric view of a vertical lift gyro assembly illustrative of an alternative embodiment for repositioning the gyro assembly with reverse motors. A typical screw gear shaft drive is shown. DETAIL A is an enlarged isometric view to show the motor's mounting clamp. DETAIL B is an enlarged isometric view to show the limit switch. DETAIL C is an isometric view to show a lift block.

FIG. 37A & B are a group of isometrics, sections and details for the variable radius gyro flywheel position type unit. FIG. 37A ISOMETRIC (ASSEMBLY WHEEL COMPONENT) is an isometric view of an alternate gyroscopic unit of the gyroscopic motion machine arranged according to an embodiment for movement of the flywheels and the motor to manipulate the reaction force of the unit. A straight tube or rod and concave rollers are utilized. SECTION A (FIG. 37B) is a cut-away view along line A (FIG. 37A) showing a position of the flywheels and motor. SECTION B (FIG. 37B) a cut-away view along line B (FIG. 37A) showing the position of the flywheels and motor. DETAIL A (FIG. 37B) is an enlarged end view to show the limit switch. DETAIL B (FIG. 37B) is an enlarged isometric view to show the motor's mounting clamp.

FIG. 38 ISOMETRIC (GYRO UNIT) is an isometric view of a of a gyro assembly similar to FIG. 28, but with an automated and improved motor mounting design with an improved location for the on/off engagement mechanism. DETAIL A is an enlarged isometric view to show the solenoid motor and swivel connection joint. DETAIL B is an enlarged isometric view to show the bearing and snap ring on the pressure lever. DETAIL C is an enlarged isometric view to show an alternative for a manual mechanism for the pressure lever. DETAIL D is an enlarged isometric view to show the motor's mounting clamp.

FIG. 39 END VIEW HYDRAULIC DRIVEN FLYWHEEL (ASSEMBLY WHEEL COMPONENT) is an end view illustrative of an alternative hydraulic motor driven flywheel used in the gyroscopic motion machine. SECTION A is a cut-away view along line A. SECTION B is a cut-away view along line B.

FIG. 40 ISOMETRIC (VTOL GYRO CRAFT) is a isometric view of a vertical lift gyroscopic motion machine mounted on a platform in accordance with an embodiment of the invention with an engine driven unit with generator and accessories. DETAIL A is an enlarged isometric view to show the motor's mounting clamp. DETAIL B is an isometric view to show a lift block. DETAIL C (OPTIONAL) is an isometric view to show an optional fan blade for engine head cooling.

FIG. 41 ISOMETRIC (VTOL GYRO CRAFT) is a isometric view of a vertical lift gyroscopic motion machine mounted on an illustrative platform in accordance with an embodiment of the invention with a engine driven generator unit and accessories and with a magnetic coupling for changing the drive speed. DETAIL A is an enlarged isometric view to show the motor's mounting clamp. DETAIL B is an isometric view to show a lift block. DETAIL C (OPTIONAL) is an isometric view to show an optional fan blade for engine head cooling.

FIG. 42 ISOMETRIC (GYRO CART) is an isometric view of a multi-gyro component set (each with multiple pairs) packaged as a unit, arranged in a straight line row. Each pair will be additive for an accumulative reaction force. DETAIL A is an enlarged isometric view to show the motor's mounting clamp.

### DETAILED DESCRIPTION OF THE INVENTION

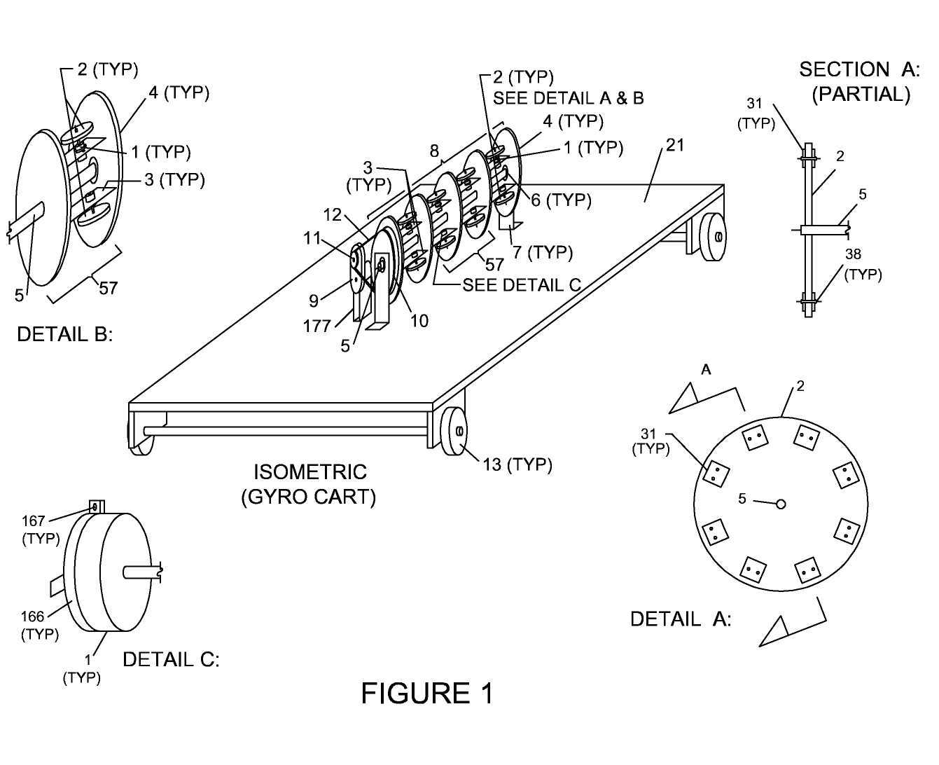

Referring now to the drawing and in particular to FIG. 1, the gyroscopic motion machine includes at least one unit that has a gyro electric motor (1) and a flywheel pair (2). The flywheel pair includes a first flywheel and a second flywheel positioned opposite each other, at 0 and 180 degree (on start up) that will be mounted with the cross bracing (3) and spacer for typically two or more disks components (4), also referred to herein as disks (4), to mount into the gyro assembly wheel (8), also referred to herein as the assembly wheel unit (8). The disks (4) are spaced in parallel spaced relation in uniform position with no offset and define a space in which one or more flywheel pairs (2) are sandwiched or situated between and inside of the space between a pair of disks (4). This unit detail is for horizontal motion where the assembly wheel unit in situated horizontal with the disks (4) being vertically disposed on a horizontal shaft (5). The gyro assembly wheel (8) is mounted on a cart frame (21) to demonstrate an exemplary embodiment of the machine. The flywheels of the flywheel pair (2) are directly coupled to the first and second motors (1) for clockwise and counterclockwise rotation. The motor shaft may have a threaded connection or other method for connecting the flywheel. The assembly wheel (8) can be different shapes such as an oval but will hold the pairs of gyro flywheels and motors in place. Also the assembly wheel (8) will be rotated in one direction to produce a reaction force. Therefore a shaft (5) and bearings (6) and framing supports (7) are required for the assembly wheel (8). Bearings (6) and supports (7) are on each side of the assembly wheel (8). Also for the drive or rotation, a gear motor (9) is required with a set of driver pulleys (10 and 11) and a belt (12), one larger pulley mounted (10) on the assembly wheel shaft (5) and one smaller pulley (11) mounted on the drive gear motor unit (9). This drive motor unit (9) could be a standard full speed motor without gear reduction. The drive motor (9) effective rpm speed of the shaft output could be controlled by various methods for either the normal speed motor or the slower gear motor. Detail A shows the motor (1) with a clamp (166) and bolt (167). The framing component includes the additional parts (7 and 177) that are shown.

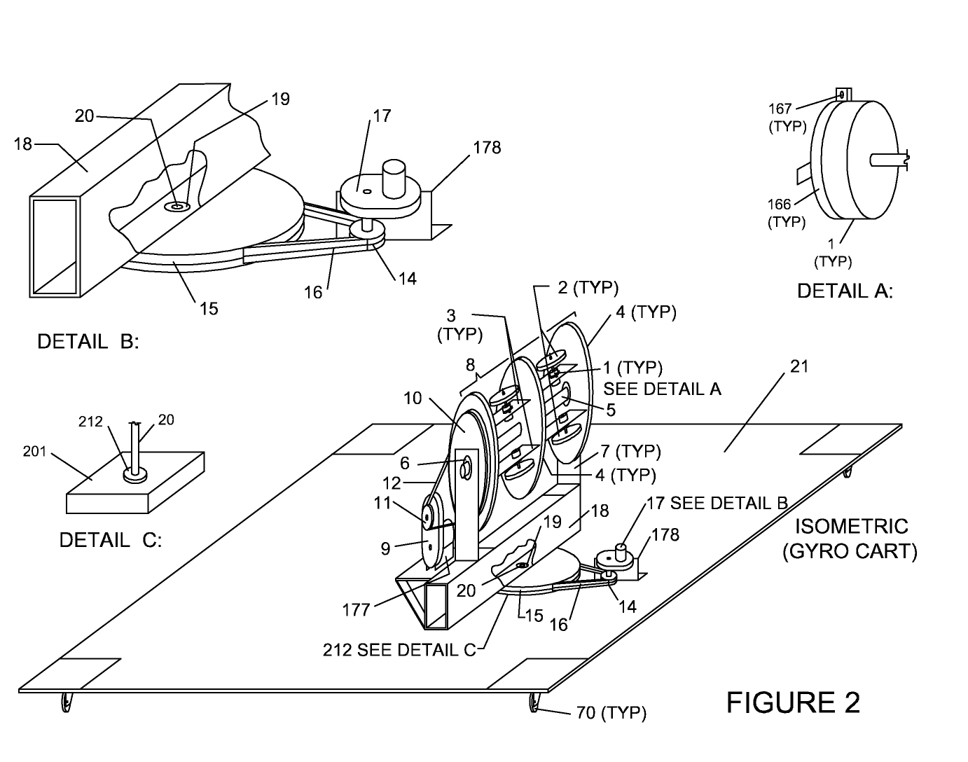

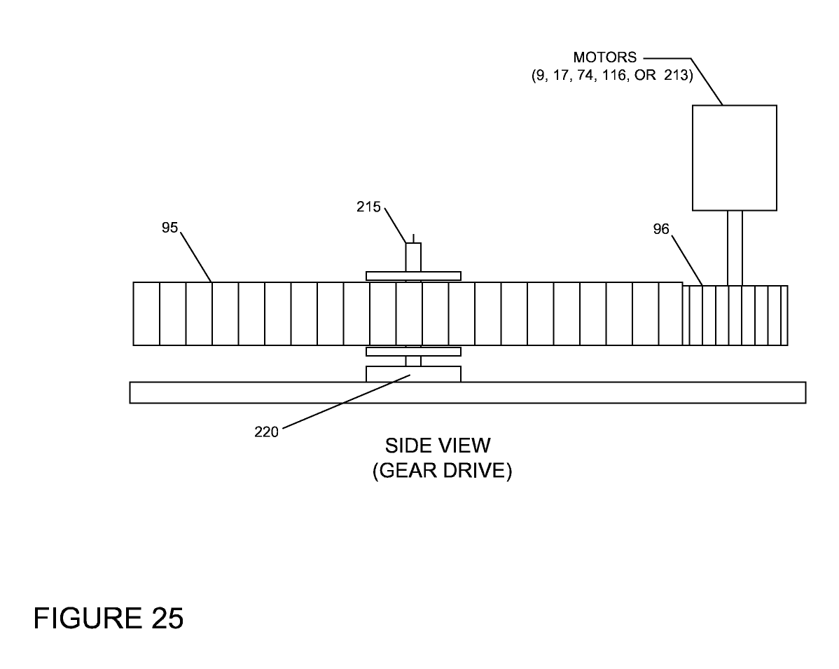

The position of the assembly wheel (8) would be such as to yield a parallel force with the road, with no pushing into the pavement. A first gyro motor (1) and flywheel (2) will turn counter-clockwise and the a second motor and flywheel will turn clockwise, which will allow the assembly wheel (8) to create a reaction force, when it is rotated by a drive gear motor (9). The drive gear motor unit (9) could be a forward and reverse motor. An alternate construction includes large and small gears in lieu of pulleys for both drive system pulleys and for the turning system pulleys. (See FIG. 25 and FIG. 2.) A force is created by the rotation of the assembly wheel (8) when the gyro flywheels (2) are energized. Cart wheels or tires (13) are mounted on the craft framing for straight motion. Stacking the disk assembly wheel components (in rows) (57) will be additive for each component (57) to the total reaction force. A linear increase in the reaction force for each component (57) is the result. The stacking components (57) include the disk (4) with the gyro motors (1) and flywheels (2) as a single pair mounted inside.

Referring to Detail A of FIG. 1, the flywheel (2) will be typically be light weight material for the disk, and have heavier metal weights (31) attached at the outer edges. Many construction techniques are possible such a wood or aluminum disk with heavy metal weights attached (31). SECTION A: (PARTIAL) shows the attachment hardware, which include bolts or rivets (38). All shafts are noted (5) for common part function and notation. However, the shafts (5) all have different diameters and lengths according to the individual specifications.

In FIG. 2, a steering electric gear motor (17) can be used to turn the complete assembly for steering the reaction force in other directions and likewise movement. The steering gear motor (17) would rotate the assembly wheel in angular position for movement in different directions. The wheels (70) for the craft would be swivel type, to accommodate any directional force. The steering gear motor (17) should be a forward and reverse motor. Large pulley (15) and smaller pulley (14) for the gear motor (17) with a belt drive (16). The shaft (20), connecting hub (19) and bearing (212) for the steering drive allow the whole assembly to turn. Only a 180 degree rotation is required, since the gyro assembly drive gear motor (9) will be reversible. Swivel type wheels (70) are utilized for complete maneuverability to be used for man-lifts, etc. Detail A shows the motor (1) with a clamp (166) and bolt (167). DETAIL B shows the steering pulley (15) and the steering gear motor (17). DETAIL C shows a lift block (201) for the bottom support bearing (212) and shaft (20). This maintains a clearance for the bottom pulley (15) and the cart (21). An alternate construction includes large and small gears in lieu of pulleys for both drive system pulleys and for the turning system pulleys. (See FIG. 25.) This could replace the required gear motors with a standard motors and separate gears for the needed turn down. The gear motors (9 or 17) could be a standard full speed motors without gear reduction. The motors (9 or 17) effective rpm speed of the shaft output could be controlled by various methods for either the normal speed motor or the slower gear motor. The framing components include the additional parts (7, 18, 177 and 178) that are shown. As mentioned previously, part numbers (1, 2, 3, 4, 5, 6, 8, 10, 11, and 12) are shown and identified.

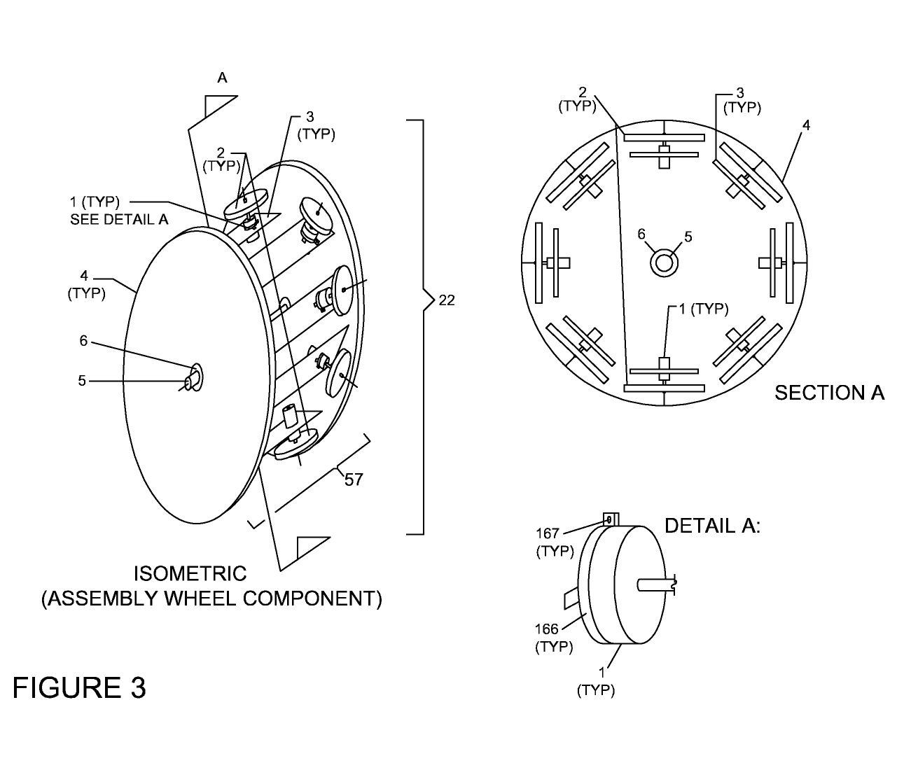

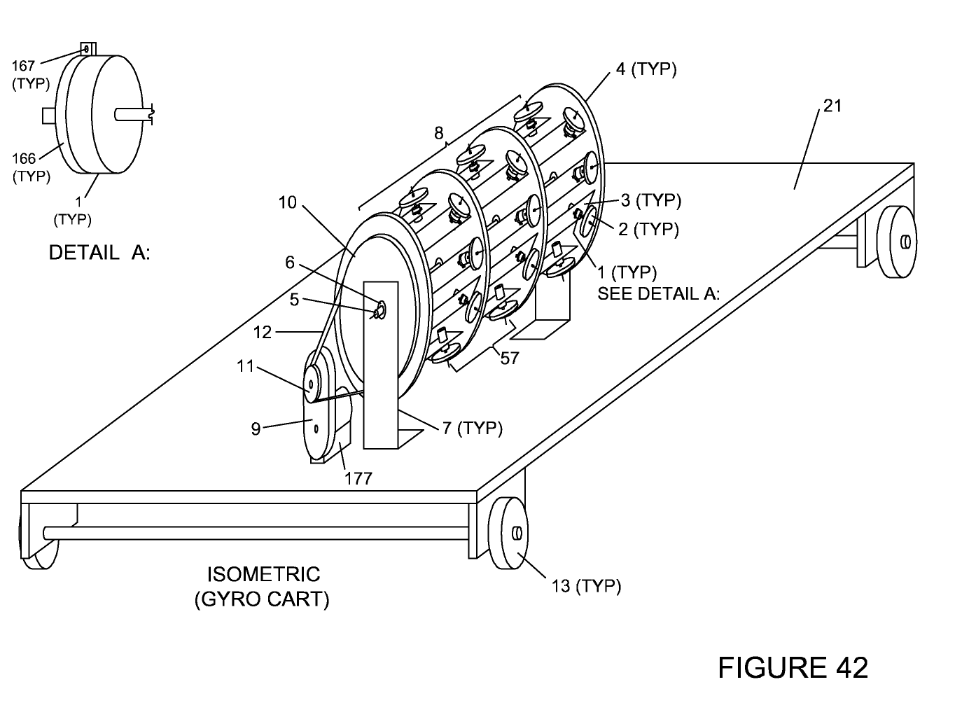

In FIG. 3, an alternate for the multi-row type gyro assemblies is a gyro assembly (22) with multi-pairs arranged in pairs (with 180 degree positioning of the flywheels) as a single component (57). However, multiple components (57) could again be stacked in a row for additional options, see FIG. 42. The angular positioning and rotation order is important and is described elsewhere. Detail A shows the motor (1) with a clamp (166) and bolt (167). As mentioned previously part numbers (1, 2, 3, 4, 5, 6 and 57) are shown and identified. The component (57) is stackable, as previously described, etc. for other units. The cart and framing are not shown for clarity. (Refer to other figures for the cart drawings.)

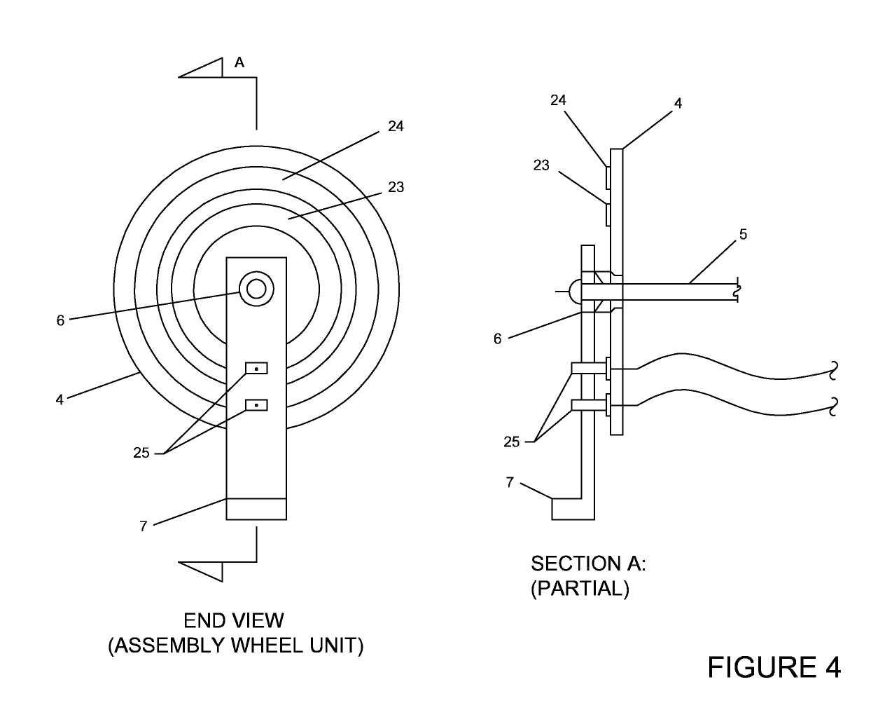

In FIG. 4, bronze washer like rings (23 & 24) for electrical current delivery is required utilizing typical motor type brushes (25) with internal springs. One outer ring (24) and one inner ring (23) would be mounted on one disk. Two different size rings, of course, is required. Alternately one ring (23) of the same size ring could be mounted on the two disk, one on each side. The feeder wires are shown leading away from the rings, but are not identified. As mentioned previously part numbers (4, 5, 6 and 7) are shown and identified.

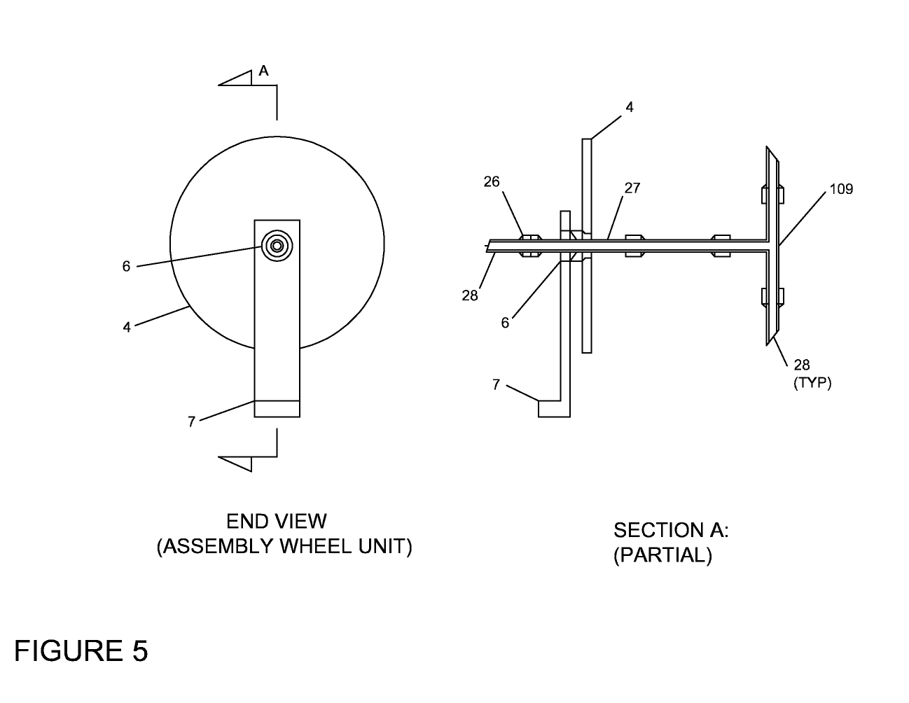

In FIG. 5, a hollow shaft (27) and swivel joint (26) permits delivery of fuel to the inside of assembly wheel for routing. On the outside of the assembly wheel unit a swivel joint (26) makes connection to a fuel line (28). On the inside, a fuel line (28) routes fuel to both engines. A tee (109) connection is required. One engine (29) will turn counter clockwise and the other engine (29) clockwise. This design will allow the assembly wheel (8) to remain symmetrical. As mentioned previously part numbers (4, 6, and 7) are shown and identified. The part numbers (8 and 29) mentioned above are not shown in FIG. 5, but are shown in other Figures.

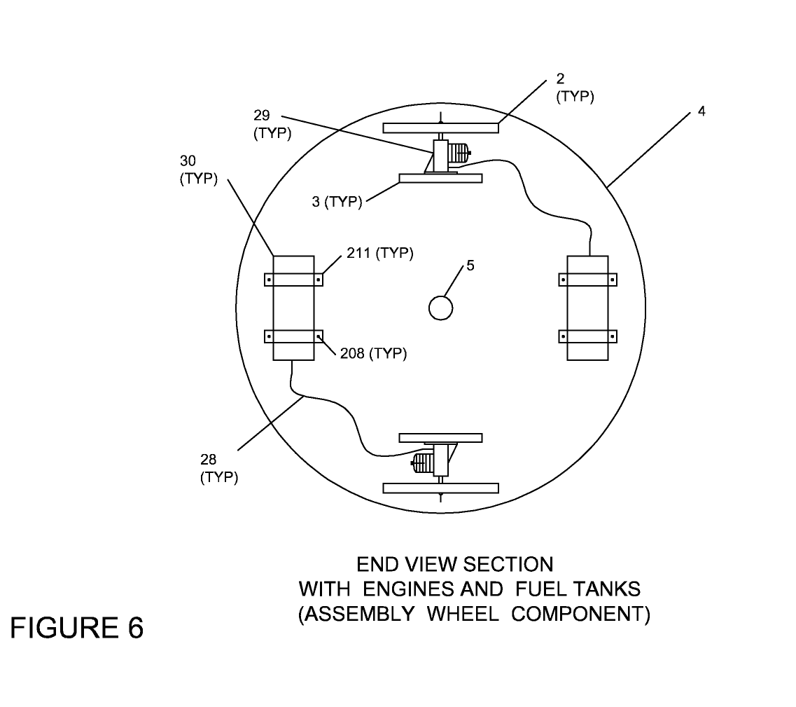

In FIG. 6, engine (29) driven flywheels (2) can be used as an alternate. On board fuel tanks (30) can be used, mounted inside the assembly wheel (8). Each fuel line (28) connects each tank (30) to its respective engine (29). The position could be 90 and 270 degrees staggered away from the gyro flywheels (2) to partially help with the dynamic balancing, and provide a more even distribution of weight around the disk. The fuel tank is attached to the disk (4) by a mounting clamp (211) and bolts, rivets or screws (208). However, a fuel delivery system can be utilized by using a swivel joint (26) on the disk to allow the fuel to be delivered to the engine. (See FIG. 5 for the swivel joint (26).) This is an alternate flywheel drive system shown in FIG. 1. As mentioned previously part numbers (3 and 5) are shown and identified.

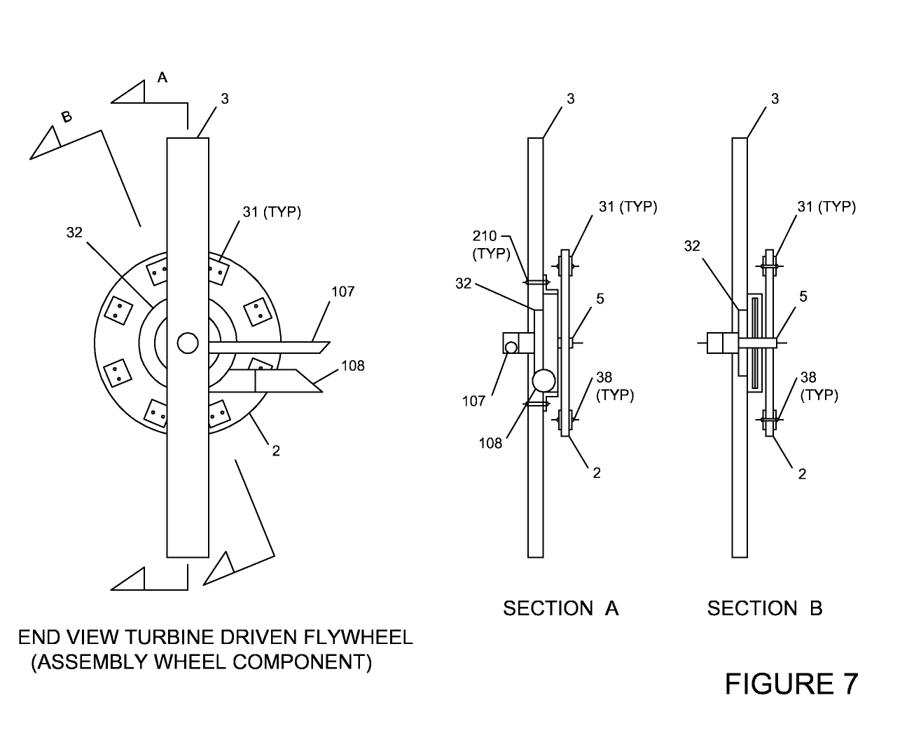

In FIG. 7, a turbine drive system is an alternate drive for the flywheels (2). The turbine (32) is mounted on the cross brace (3). An air pressure driven turbine (32) has two pipes, the inlet (107) and the outlet (108). The outlet (108) is not piped, but will be a free discharge for the air pressure turbine unit. The inlet (107) is connected to the air pressure piping. A swivel joint (26) is used for the supply air pressure with a pipe connection to a hollow shaft (27). (See FIG. 5 for the swivel joint (26).) A vacuum turbine (32) system is another alternate but the piping will connect to the low pressure side, which is labeled (108) (mentioned previous as the outlet (108)). Both the pressurized air and vacuum turbine systems would be essentially the same drawing. A steam turbine can also be utilized. The drawing is not changed but the inlet (107) and outlet (108) connection will be piped. The steam supply (107) and the return for the condensate (108) will be piped. For steam two swivel joints (26) are required, one on each side of the assembly wheel (8). (See FIG. 4) Attachment hardware includes bolts or rivets (38) for the flywheel weights (31). The turbine is attached to the disk (4) by bolts, rivets, or screws (210). As mentioned previously part numbers (5) is shown and identified.

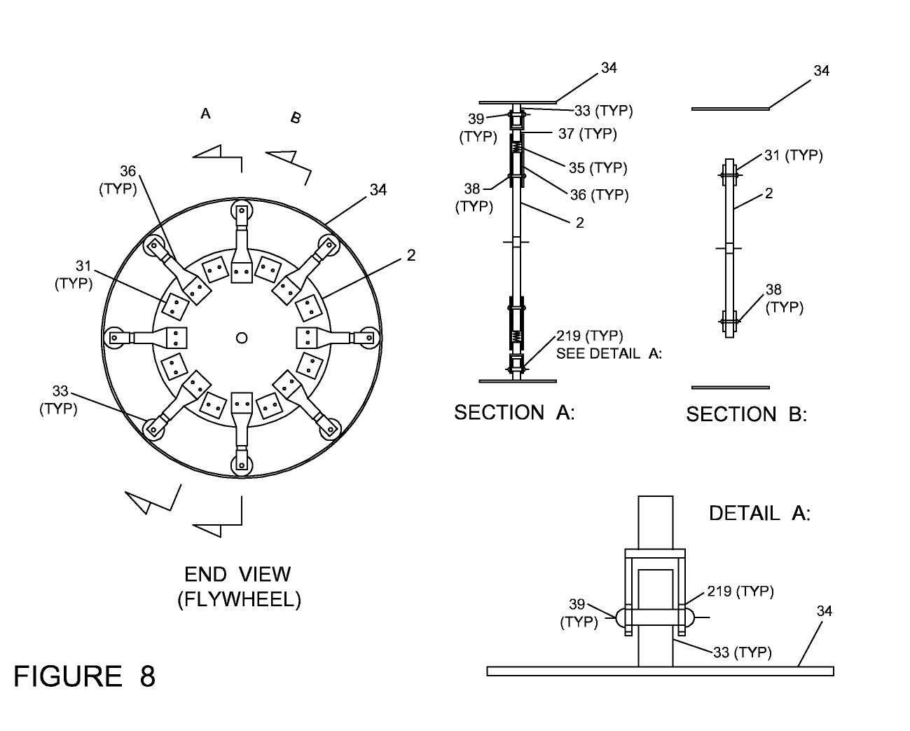

In FIG. 8, a sleeve (34), mounting bracket and tube (36), rollers (33) and pin (39) with piston or shaft with piston rods (37) for flywheels with springs (35) are used for preventing excess wobble of the flywheel (2). The wobble could be due to the gyro assembly wheel (8) speed changes. Each roller has two bearing members (219) comprising of bearings, one on each side. Attachment hardware includes bolts or rivets (38). As mentioned previously, part number (31) is shown and identified. The part number (8) mentioned above is not shown in FIG. 8, but is shown in other Figures. Section A, Section B and DETAIL A are included to show the details.

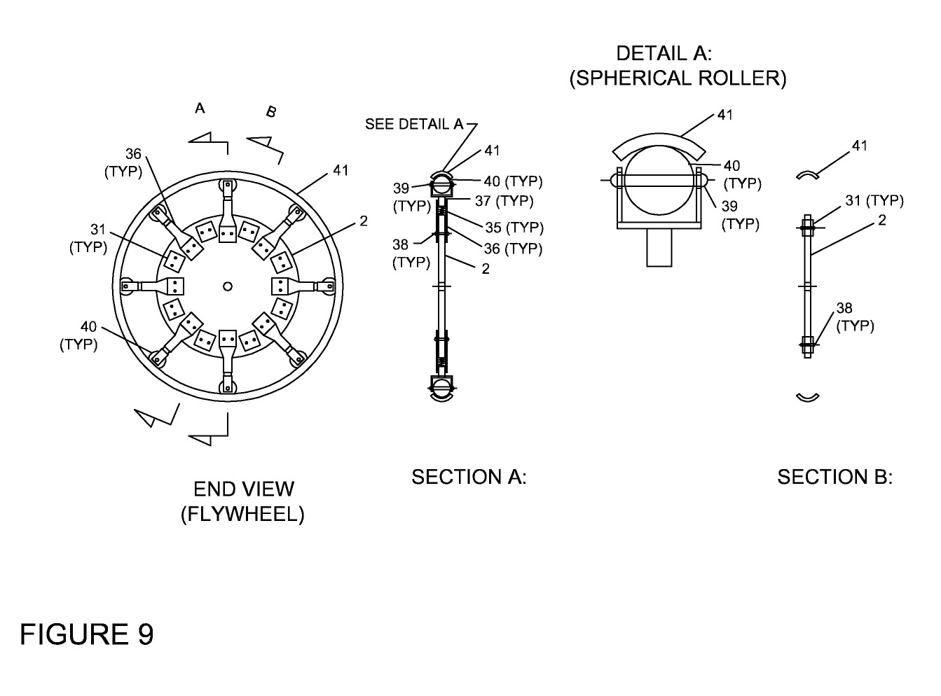

In FIG. 9, a sphere shaped roller (40) with pin (39) can be used with a trough (41) to ride. A mounting bracket and tube (36) with a piston rod (37) and a compression spring (35) are used to steady the flywheel smoothly. Attachment hardware includes bolts or rivets (38). As mentioned previously, part numbers (2 and 31) are shown and identified. Section A, Section B and DETAIL A are included to show the details.

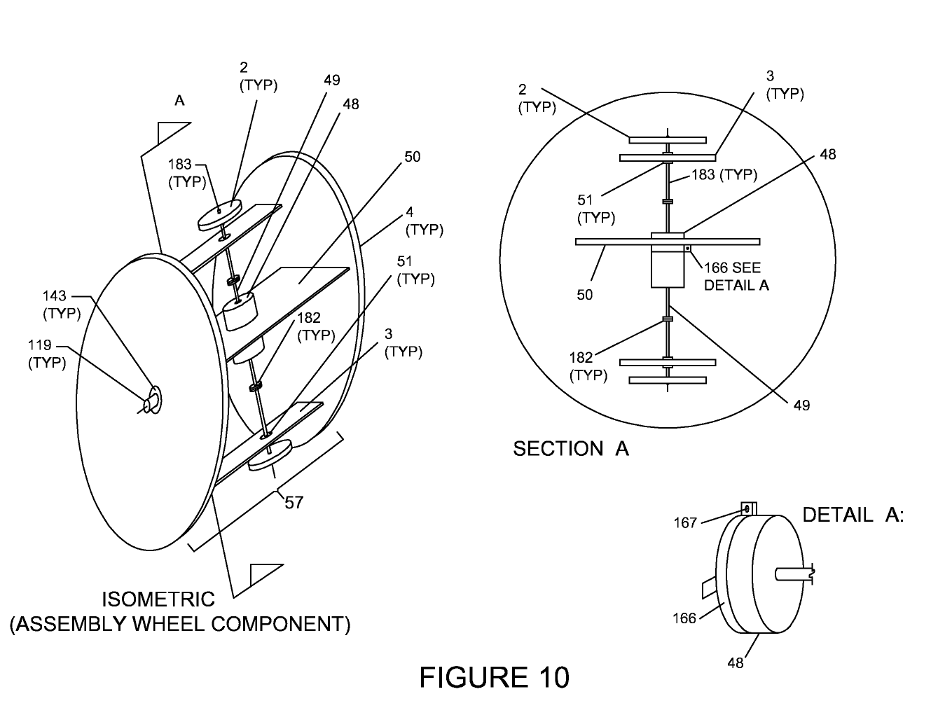

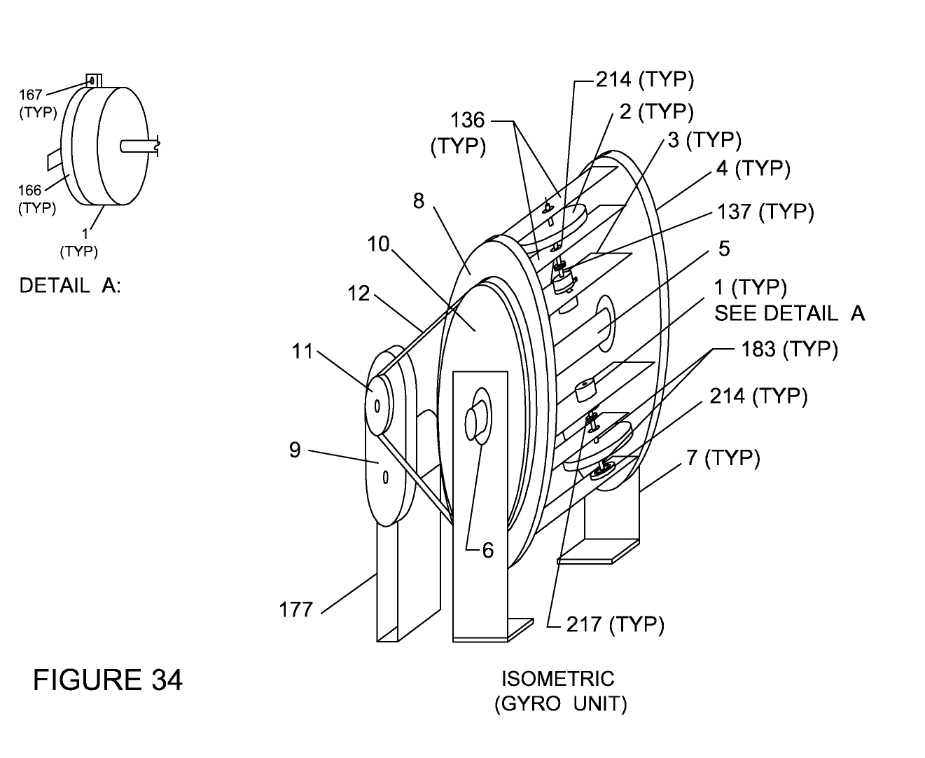

In FIG. 10, an alternate for the two gyro electric motors (1) is a double ended gyro electric motor (48) for the pair of flywheels (2). The motor could be positioned in the center of the assembly wheel component (57) for dynamically balancing the assembly wheel (8). The motor is supported on a cross brace (50). The set of shafts (49 and 183) drives both flywheels (2), making a pair. The two cross brace supports (3) hold the two bearings (51) in position, which are close to the flywheels (2). The bearings (51) can be mounted on the inside from the flywheels (2) as shown or on the outside (See FIG. 34). The external shafts (183) are connected by couplings (182) to the motor's shaft. If an extra long shaft from the motor (1) is used these two parts would not be necessary. For the component (57) the shorter shafts (119) will connect to each disk by a flange or shoulder hub connection (143) to the disk (4). One shaft (119) and flange hub (143) are required on each end of the assembly wheel (8). The hub (143) connects to the disk (4) perpendicular on both sides and makes the unit ready for the brackets that support the assembly wheel. The component (57) is stackable, as previously described, etc. for other units. Detail A shows the motor (1) with a clamp (166) and bolt (167). The cart and framing are not shown for clarity. (Refer to other figures for the cart drawings.) The part number (8) mentioned above is not shown in FIG. 10, but is shown in other Figures.

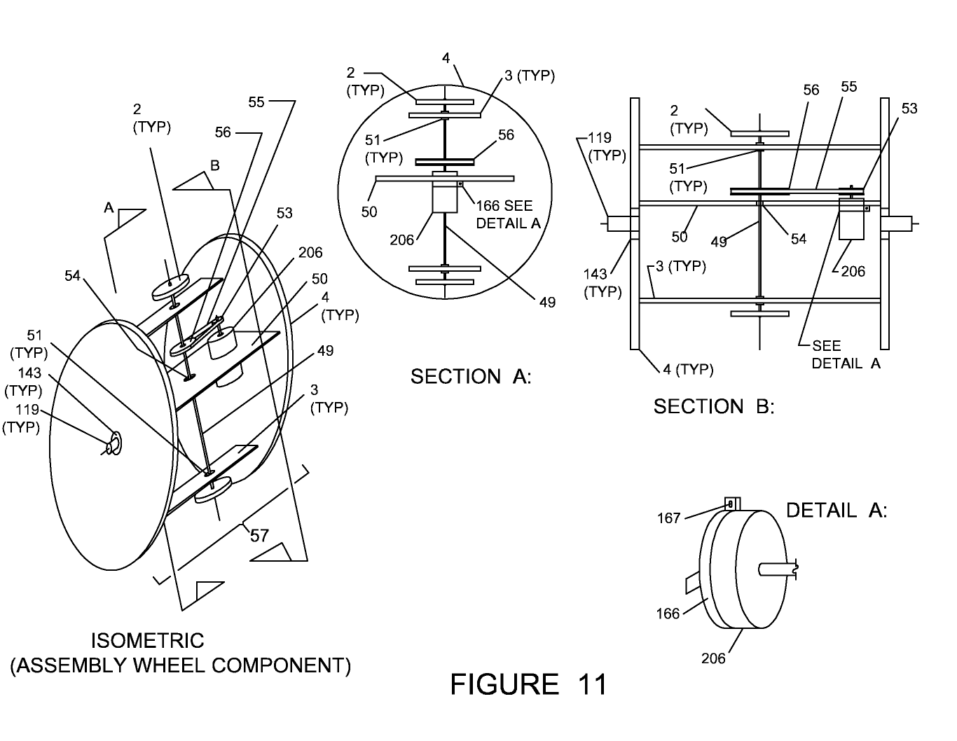

In FIG. 11, an alternate for above is a flywheel pair (2) with a long shaft (49), supported by a cross brace (3) and bearings (51), large pulley (56) and a single motor (206) with small pulley (53). The electric motor (206) is supported on a cross brace (50) with a hole (54) for the flywheel long shaft (49). A belt (55) connects the two pulleys; motor pulley (53) and shaft pulley (56). The shaft (49) goes through a hole (54) in the cross brace (50). The shorter shafts (119) will connect to each disk by a flange or shoulder hub connection (143) to the disk (4). The hub (143) connects to the disk (4) perpendicular on both sides and makes the unit ready for the brackets that support the assembly wheel. Detail A shows the motor (1) with a clamp (166) and bolt (167). The component (57) is stackable, as previously described, etc. for other units. The cart and framing are not shown for clarity. (Refer to other figures for the cart drawings.)

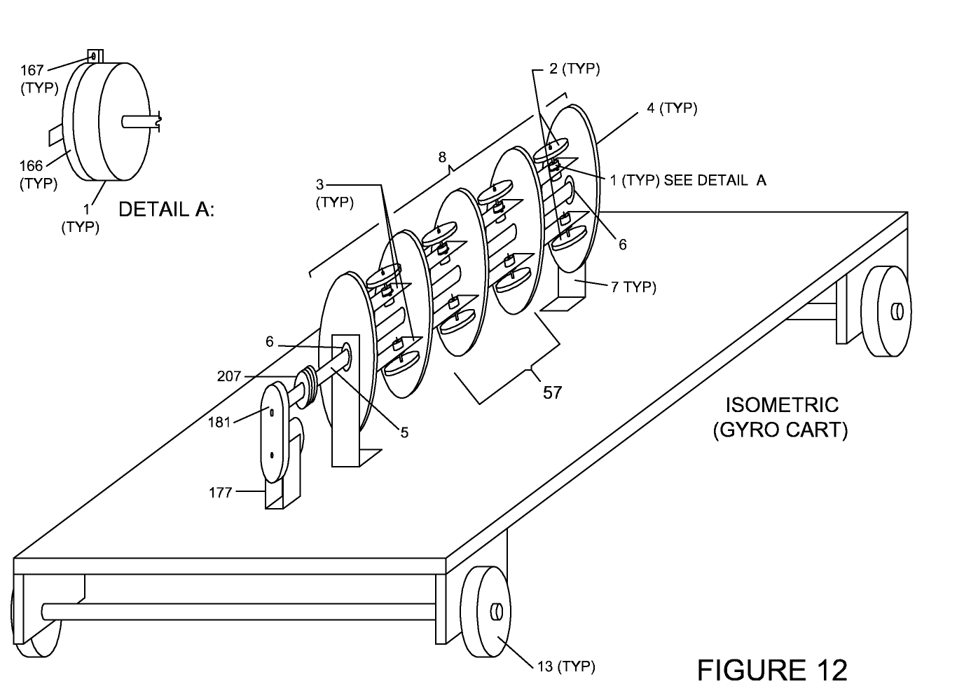

FIG. 12 illustrates a magnetic coupling (207) that could be used for speed control as an alternate mechanism. Also the drive electric gear motor (181) could be reversed in rotation for a reverse directional reaction force. This gear motor (181) has a different gear ratio than the previous gear motor (9) since it is directly coupled. This gear motor (181) has a higher gear ratio for more gear down. Detail A shows the motor (1) with a clamp (166) and bolt (167). The framing components include the additional parts (7 and 177) that are shown and identified. As mentioned previously, part numbers (1, 2, 3, 4, 5, 6 and 8) are shown and identified.

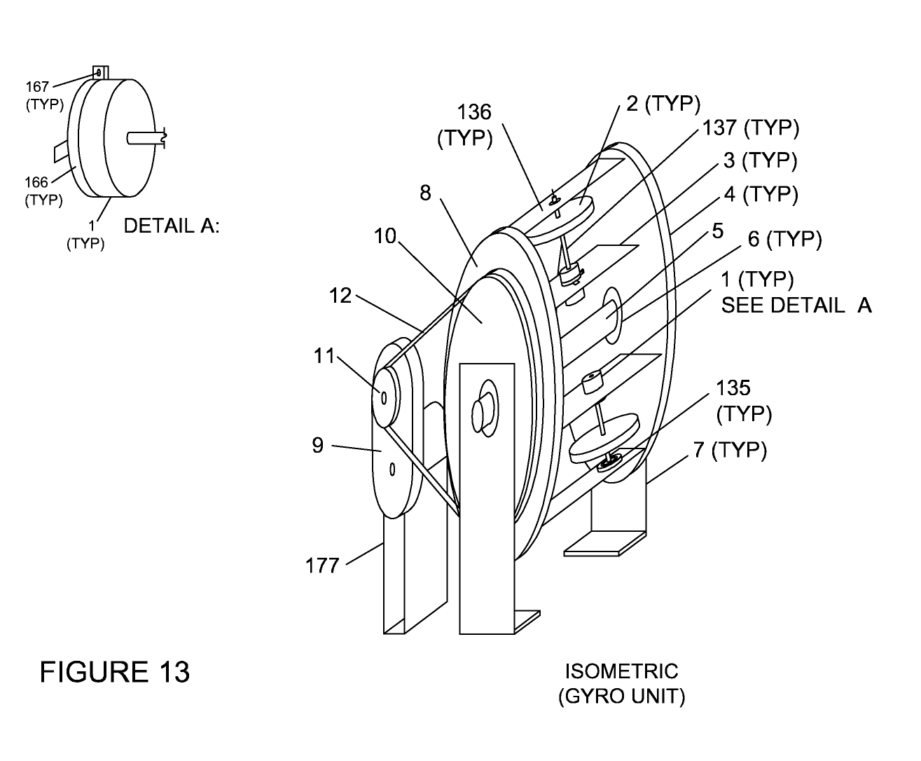

FIG. 13 shows two external additional magnetic bearings (135) for each gyro motor shaft (137). This shaft (137) is connected to and drives the two flywheels (2) normally, but on previous figures without external magnetic bearings (135). The two cross brace supports (136) hold the two additional magnetic external bearings (135) in position, etc. The shafts (137) for the motor are long and run into the external magnetic bearing (135). Detail A shows the motor (1) with a clamp (166) and bolt (167). The cart is not shown for clarity. (Refer to other figures for the cart drawings.) The framing components include the additional parts (7 and 177) that are shown. As mentioned previously, part numbers (1, 2, 3, 4, 5, 6, 7, 8, 9, 10, 11, 12) are shown and identified.

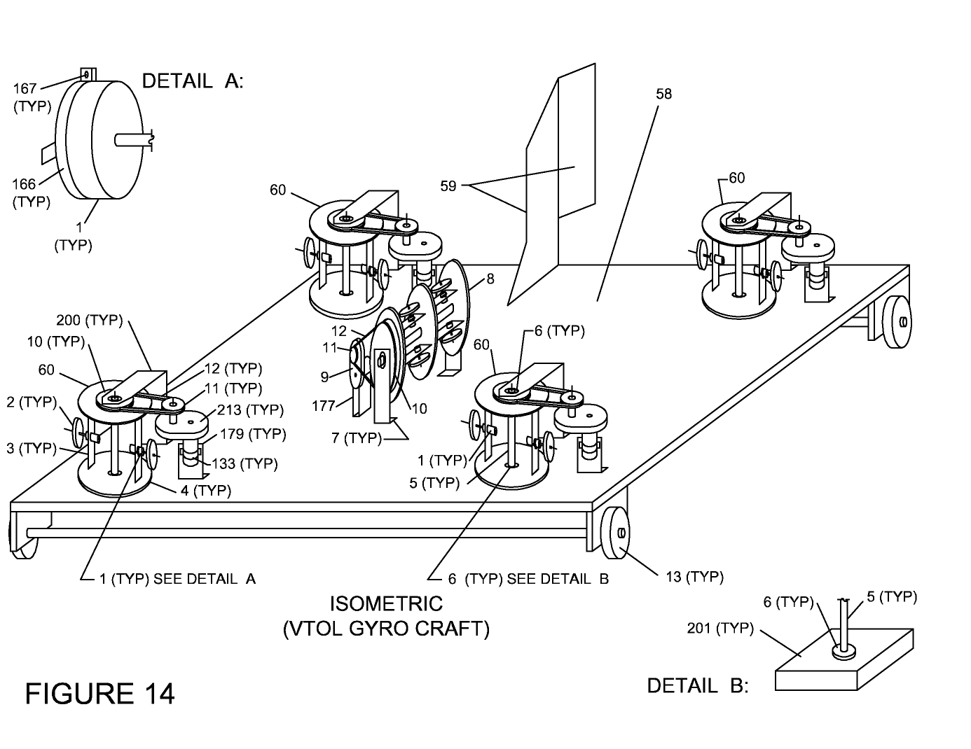

FIG. 14 relates to vertical lift units. In addition to above, special designs would permit the craft to lift up, become airborne, and fly. For vertical lift gyro assemblies (60) for the craft would be positioned on typically four corners of a craft platform (58) with rudder (59). We are not dependent on forward speed of the craft for normal aircraft wings for lift; horizontal motion is possible by a adding gyro assembly (8) for horizontal motion with a rudder (59) for turning. A control mechanism for the rudder (59) is not shown. In lieu of a rudder (59), a simple steering motor system with part numbers (14, 15, 16, 17, 18, 19, 20, 133, 178 and 201) could be added to the horizontal unit for moving in any direction. A forward and reverse steering motor (17) and drive gear motor (9) for the horizontal unit should be utilized also. An on board electric power generation system for power can be utilized or power delivery systems could be utilized, such as a trolley car power track system. Also several power plant engines could be used for the flywheel electric motors etc. On board fuel storage, etc. would be provided. The drive gear motor (213) is held in place by the mounting clamp (133). The drive gear motors (213) for the vertical lift gyro assembly units (60) are forward direction only. (CCW rotation looking from above the unit.) A top support bracket (200) is shown for the top bearings (6). The bottom bearings (6) and supports are not visible, but are required. DETAIL B shows a lift block (201) for the bottom support bearing (6) and shaft (5). This maintains a clearance for the bottom disk (4) and the framing (58). Detail A shows the motor (1) with a clamp (166) and bolt (167). A top support bracket (200) is included for the top bearings (6). The drive gear motors (9 or 213) could be standard full speed motors without gear reduction. The drive gear motors (9 or 213) effective rpm speed of the shaft output could be controlled by various methods for either the normal speed motor or the slower gear motor. The framing components include the additional parts (7, 177, 179, and 200) that are shown. As mentioned previously, part numbers (1, 2, 3, 4, 5, 6, 10, 11, 12 and 13) are shown and identified.

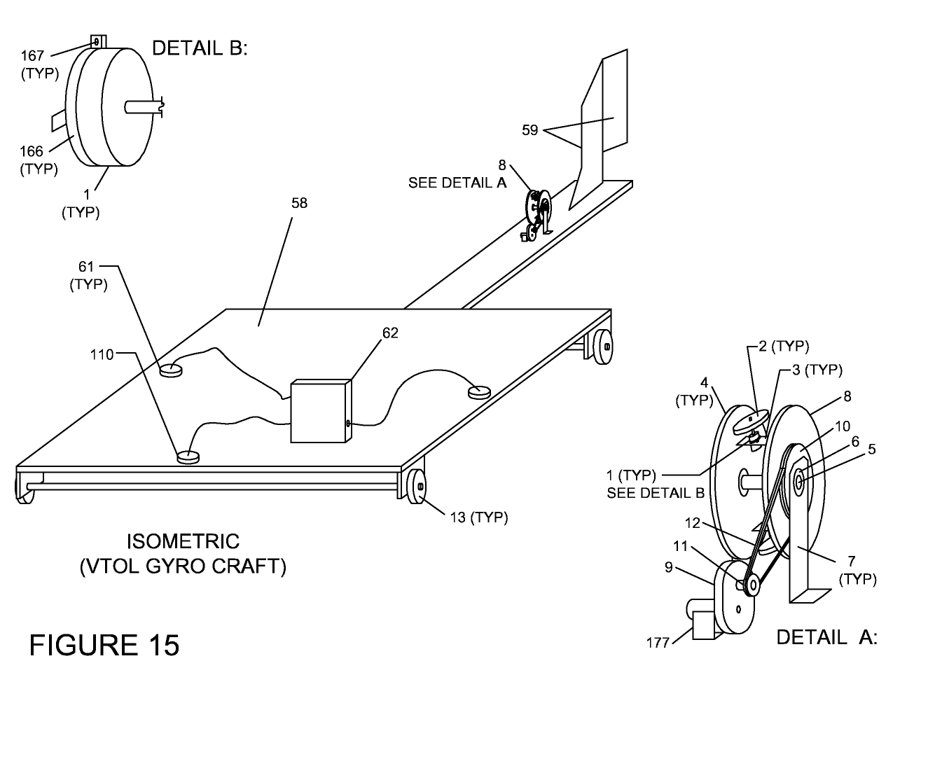

Referring to FIG. 15, horizontal and vertical lift gyro assemblies are not shown for clarity, but would be exactly the same or very similar to FIG. 14 above. When the craft is airborne a smaller stabilizer gyro wheel assembly unit (8) will counteract the expected reactionary torsion force for the four vertical lift gyro assemblies, similar to a helicopter stabilizer rotor. The unit is to point opposite of the main reactionary torsion (horizontally) and be positioned for maximum leverage and minimum additional weight. The horizontal gyro assembly for forward motion would also require some stabilization to prevent tilting. The speed for the vertical lift gyro assemblies could be adjusted, with one side having a faster rotation speed than the other side to resist the torsion effect of the forward motion gyro unit. This could compensate for the tilting without additional equipment such as gyro assembly wheel (8) units or other systems such as a ballast system, etc. A VFD (Variable Frequency Drive) controller (62) for the assembly wheel drive gear motor (9) will be used for speed control and likewise the reaction force. A tilt and VFD controller (62) for the craft with tilt sensors (61) will be utilized for level flight and flight elevation, etc. Each gyro assembly on each corner of the craft could be adjusted for speed to maintain level flight. Tilt sensors (61) will allow level flight, at 2 locations for each direction.

An elevation sensor (110) would likewise allow the controller (62) to accurately maintain, increase or decrease the altitude. The drive motors (9) effective rpm speed of the shaft output could be controlled by various methods for either the normal speed motor or the slower gear motor. Detail A shows the motor (1) with a clamp (166) and bolt (167). Detail B shows the motor (1) with a clamp (166) and bolt (167). The framing component includes the additional part (177) that is shown. As mentioned previously, part numbers (1, 2, 3, 4, 5, 6, 7, 10, 11, 12, 13, 58, and 59) are shown and identified. Pilot input for elevation horizontal direction and speed will be utilized by some type of translated format or process for control.

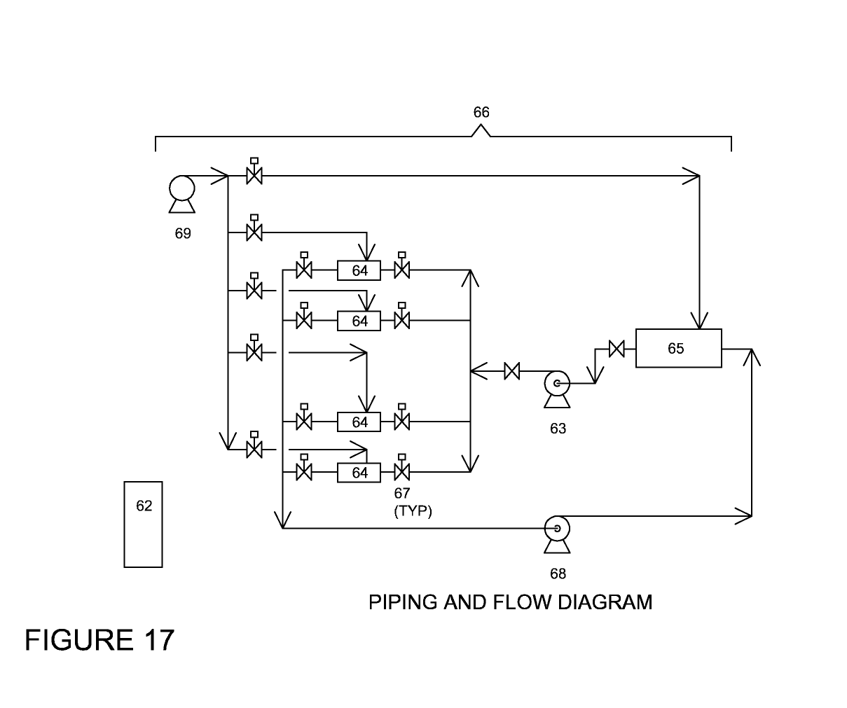

In the embodiment of FIGS. 15, 16 and 17, for level flight, a water ballast system would eliminate tilting during flight due to cargo loads, or other loads being unbalanced and not symmetrically distributed. A supply pump (63) will pump the water to separate water outer tanks (64) on the four corners of the craft. Piping system (66) with valves (67) and controller (62) will allow the platform to be stable by pumping to each outer tank (64) and returning water to the central tank (65). Return pump (68) or optional air compressor (69), or combination thereof or used together, may be used for returning the outer water tanks (64). As mentioned previously, part numbers (13, 58 and 59) are shown.

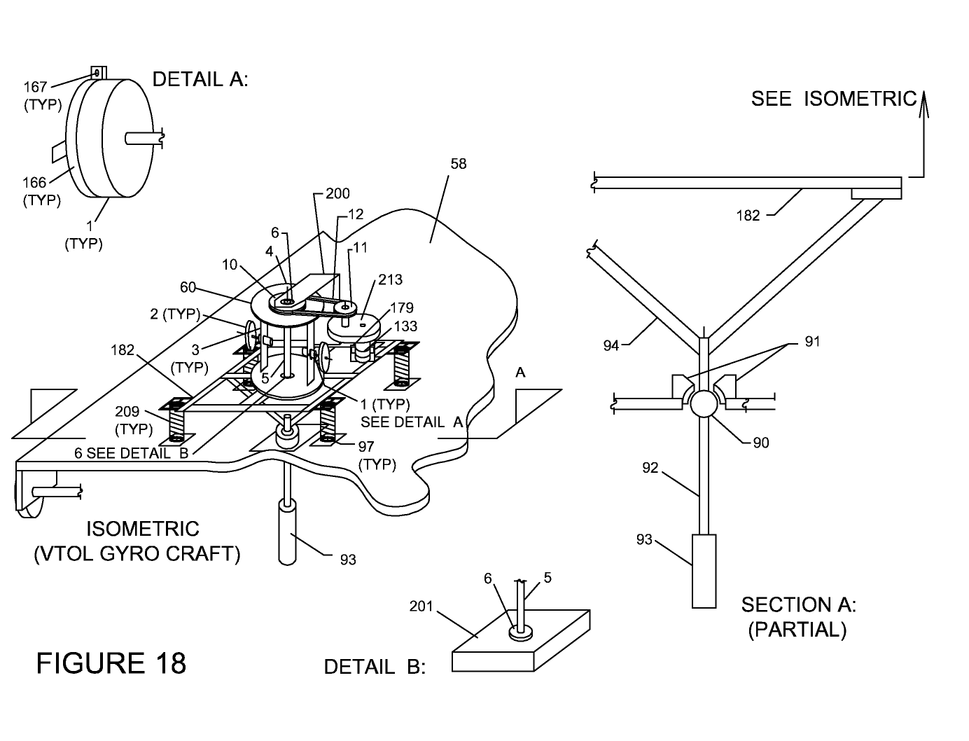

In FIG. 18, an alternative is provided that will maintain a complete vertical force at 0 degrees for each vertical lift gyro assembly (60) is a swivel mounting arrangement. It utilizes a swivel ball joint (90) and a socket (91) with a rod (92). A vertical ballast water tank (93) or a simple weight (93) allows a straightening force to turn the unit vertical. Another small framing brace (94) connects the rod with tank to the base frame (182) of the vertical lift gyro assembly (60). The four springs (209), one for each corner of the assembly, support the gyro assembly unit (60) and push the unit up into the socket so the ball joint will be engaged on start up and remain engaged. A spring cup (97) on top and bottom maintains the position of the springs (209). A strict speed adjustment by a VFD controller would be used in combination with the above to maintain level flight, and when a tilting occurs a mounted swivel system would maintain the force completely vertical. This would allow a better control system to minimize tilting. The drive gear motor (213) is held in place by the mounting clamp (133). The drive gear motors (213) for the vertical lift gyro assembly units (60) are forward direction only. (CCW rotation looking from above the unit.) A ball joint (90) allows the entire unit (60) to swivel inside the socket (91), yet is held in place and transfers the vertical force to go to the connecting framing (58). Detail A shows the motor (1) with a clamp (166) and bolt (167). A top support bracket (200) is included for the top bearings (6). DETAIL B shows a lift block (201) for the bottom support bearing (6) and shaft (5). This maintains a clearance for the bottom disk (4) and the framing (182). The drive motor (213) could be a standard full speed motor without gear reduction. The drive motor (213) effective rpm speed of the shaft output could be controlled by various methods for either the normal speed motor or the slower gear motor. The framing components include the additional parts (94, and 179) that are shown and identified. As mentioned previously, part numbers (2, 3, 10, 11, and 12) are shown and identified.

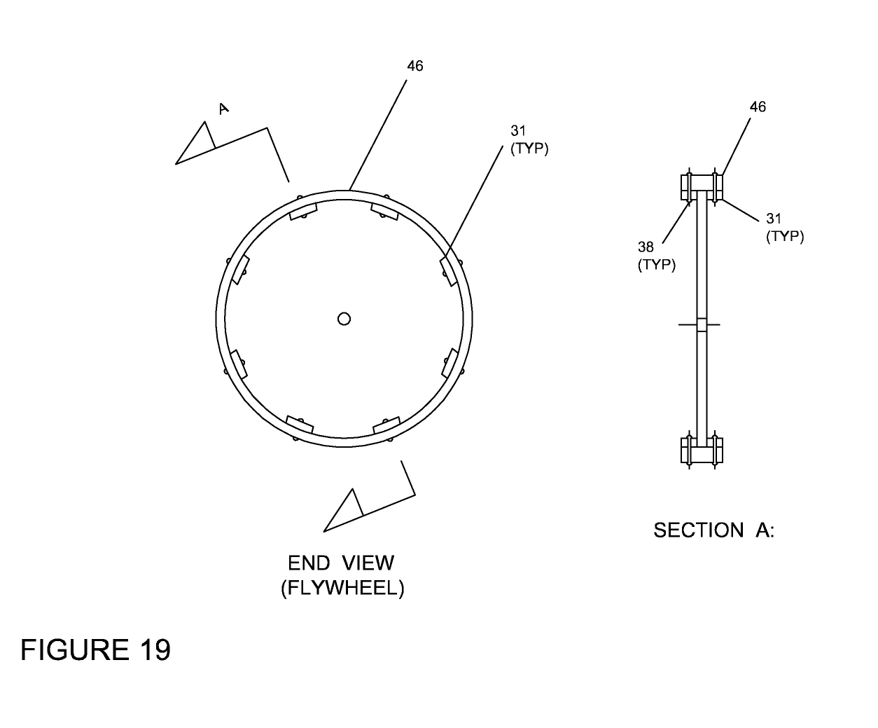

FIG. 19 shows an alternate for a disk flywheel (2), which is a rim flywheel (46) with weights (31) about the perimeter. The weights are attached and held in place by rivets or bolts (38).

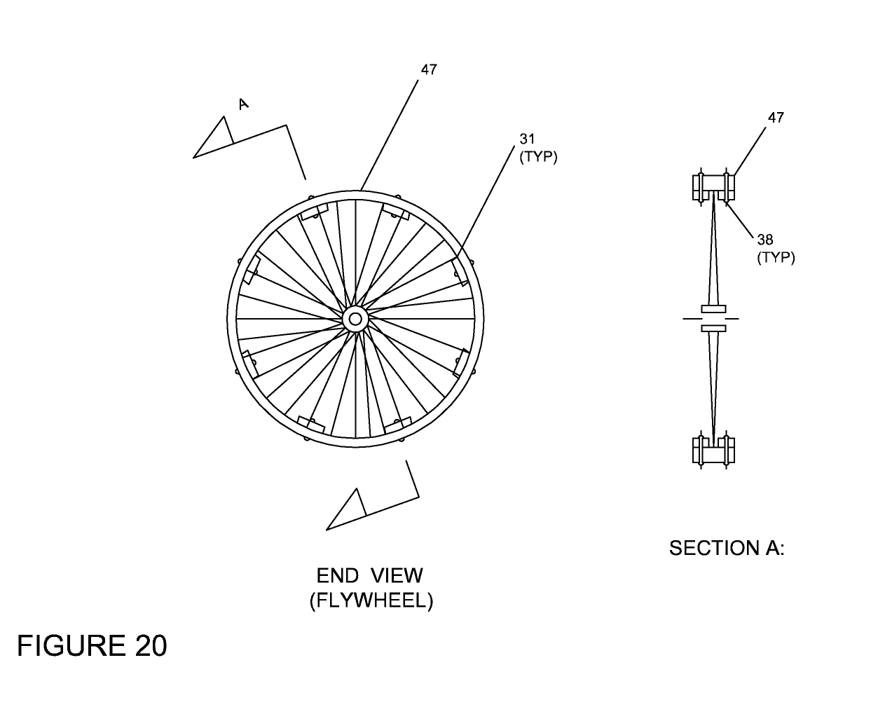

FIG. 20 shows an alternate construction for the gyro flywheel is normal spoke rim wheels (47) utilized for the flywheels with normal connection to the motor shaft (5). Flywheel weights (31) will be attached to the rim. Attachment hardware includes bolts or rivets (38).

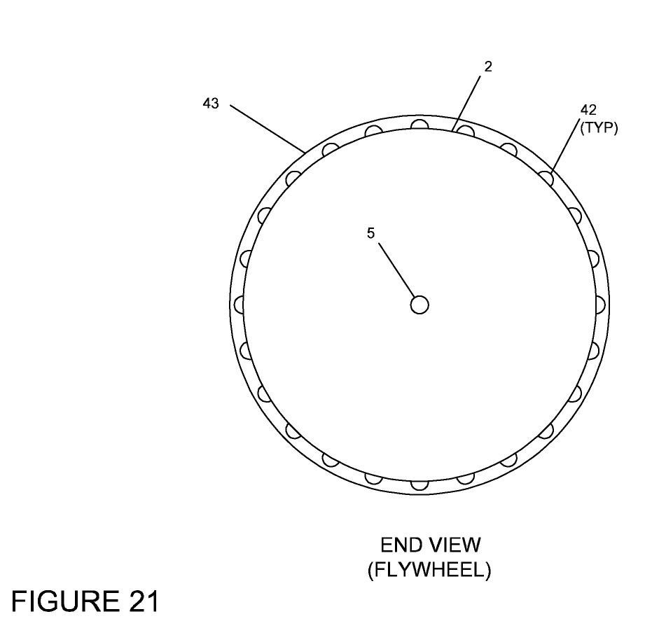

FIG. 21 shows an embodiment similar to FIG. 8 above, to prevent the flywheels (2) from wobbling and for smaller applications utilize skid knobs (42) with a sleeve (43). As mentioned previously, part number (5) is shown and identified.

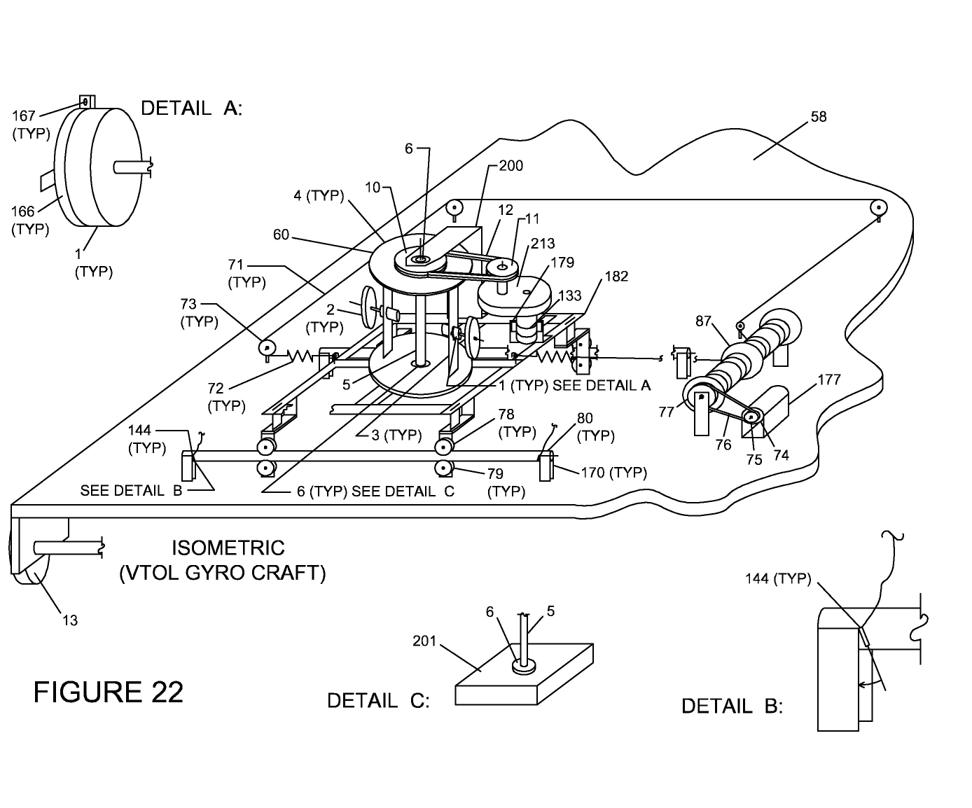

Alternately or used in combination with other level flight systems, the vertical lift assembly wheel units (60) can be repositioned to stabilize the platform as illustrated in FIG. 22. A cable system with a double acting reel (87) would move the gyro assembly in lieu of a ballast system. A cable (71) connects on each side of the gyro assembly with springs (72) and idler pulleys (73). The idler pulleys have a deep groove for maintaining the cable routing. The reel motor (74) and pulley (75) are connected by a belt (76) to the reel pulley (77). The reel motor (74) is reversible. The motion will be limited, and the motor will be protected from overloading. The tube rail or pipe (80) is used for a guide system for smooth movement. It uses double wheel rollers each side with a top (78) and bottom (79) roller for a clamping type positioning. (One tube rail system on each side of the gyro assembly makes the system complete.) The tube rail (80) is supported by a framing mount (170) on each end. The springs (72) will maintain the cable tension to prevent the cable from getting too loose. The drive gear motor (213) is held in place by the mounting clamp (133). The drive gear motors (213) for the vertical lift gyro assembly units (60) are upward direction only. (CCW rotation looking from above the unit.) Only one limit switch (144) is required for each direction (in or out), since turning the reel motor (74) off with the one switch (144) will allow the stopping position of each roller wheel (78) to be identical. (See DETAIL B.) Controls will be needed for restarting the reel motor (74) in the opposite direction for the next engagement after a limit switch has deactivated the drive motor. DETAIL A shows the motor (1) with a clamp (166) and bolt (167). A top support bracket (200) is included for the top bearings (6). DETAIL C shows a lift block (201) for the bottom support bearing (6) and shaft (5). This maintains a clearance for the bottom disk (4) and the framing (182). The drive motor (213) could be a standard full speed motor without gear reduction. The drive motor (213) effective rpm speed of the shaft output could be controlled by various methods for either the normal speed motor or the slower gear motor. The framing components include the additional parts (170, 177, 179, 182, 200 and 201) that are shown and identified. As mentioned previously, part numbers (1, 2, 3, 4, 10, 11, 12, 13 and 58) are shown and identified. The reel motor (74) could be replaced with a gear motor.

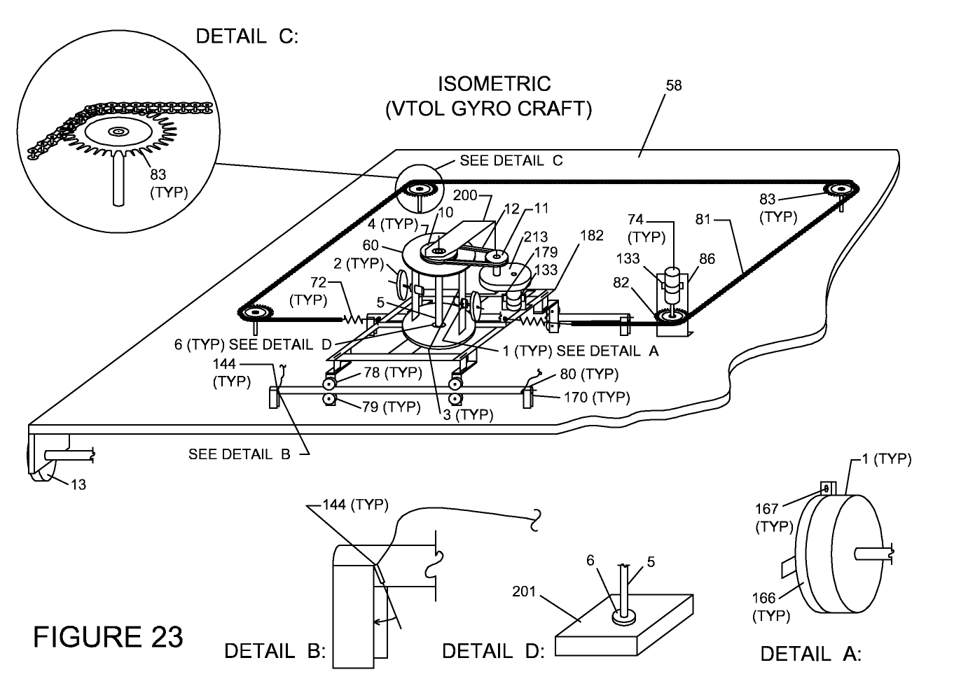

Alternately, as in FIG. 23, a chain (81) and sprocket drive (82) and motor (74) with several idler sprockets (83) can be utilized. The sprocket drive motor (74) is held in place by the mounting clamp (133). The motion will be limited, and the motor protected from overloading.

The sprocket motor (74) turns the drive sprocket (82) and the chain (81) pulls the gyro assembly (60) in or out. Springs (72) on each side maintains the tension for the drive. The drive gear motor (213) is held in place by another mounting clamp (133). The drive gear motors (213) for the vertical lift gyro assembly units (60) are upward direction only. (CCW rotation looking from above the unit.) A top support bracket (200) is included for the top bearings (6). Detail A shows the motor (1) with a clamp (166) and bolt (167). Only one limit switch (144) is required for each direction (in or out), since turning the sprocket motor (74) off with the one switch (144) will allow the stopping position of each roller wheel (78) to be identical. (See the enlarged view, Detail B.) Controls will be needed for restarting the sprocket motor (74) in the opposite direction for the next engagement after a limit switch (144) has deactivated the drive motor (74) Detail C shows the idler sprocket (83) and chain (81). Detail D shows a lift block (201) for the bottom support bearing (6) and shaft (5). This maintains a clearance for the bottom disk (4) and the framing (58). The drive motor (213) could be a standard full speed motor without gear reduction. The drive motor (213) effective rpm speed of the shaft output could be controlled by various methods for either the normal speed motor or the slower gear motor. The framing components include the additional parts (86, 170, 179 and 182) that are shown and identified. As mentioned previously, part numbers (9, 13, 58, 60, 72, 78, 79, and 80) are shown and identified. The sprocket motor (74) could be replaced with a gear motor.

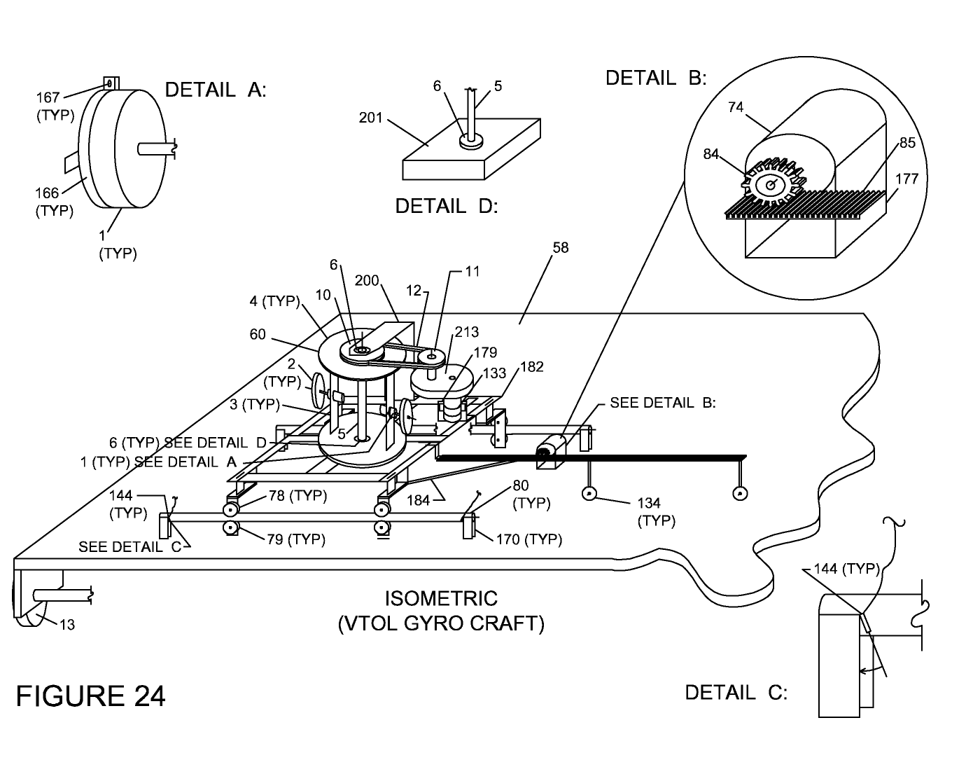

Referring to FIG. 24, to maintain level flight the vertical lift gyro assembly wheel units (60) can be moved by a smaller gear (84) with a reversible motor (74) moving a track bar gear (85). This will move the gyro assembly (60) smoothly. This could be used in combination with other ballast weight systems or in lieu of a ballast system. Also the gyro assembly speed could be controlled by the level flight and elevation controller (62). The rollers (134) provide support for the track bar gear (85). A lateral brace (184) is provided for the track bar gear (85). The drive gear motor (213) is held in place by the mounting clamp (133). The drive gear motors (213) for the vertical lift gyro assembly units (60) are upward direction only. (CCW rotation looking from above the unit.) A top support bracket (200) is included for the top bearings (6). Detail A is enlarged and shows the motor (1) with a clamp (166) and bolt (167). Detail B is enlarged and shows the motor (74) drive gear (84) and track bar gear (85). Only one limit switch (144) is required for each direction (in or out), since turning the reel motor (74) off with the one switch (144) will allow the stopping position of each roller wheel (78) to be identical. (See the enlarged view, DETAIL C.) Controls will be needed for restarting the bar gear motor (74) in the opposite direction for the next engagement after a limit switch (144) has deactivated the drive motor (74). DETAIL D shows a lift block (201) for the bottom support bearing (6) and shaft (5). This maintains a clearance for the bottom disk (4) and the framing (182). The drive motor (213) could be a standard full speed motor without gear reduction. The drive motor (213) effective rpm speed of the shaft output could be controlled by various methods for either the normal speed motor or the slower gear motor. The framing components include the additional parts (170, 177,179 and 182) that are shown and identified. The framing component (179) is utilized for supporting two different motor units (74 and 213) in the very same manner. Both are very similar in shape. However, they are sized differently. As mentioned previously, part numbers (1, 2, 3, 4, 10, 11, 12, 13, 58, 78, 79, and 80) are shown and identified. The bar gear motor (74) could be replaced with a gear reduction motor unit.

In lieu of mechanical movement and/or used in combination with the above, the speed of the gyro assembly wheels (60) for lift could be adjusted for a separate speed for each corner unit (60) individually. (See FIG. 22, etc.) An extensive control system (62) would allow this. (See FIG. 15.) Typically, a separate VFD drive system (62) for each gyro assembly wheel drive gear motor (9) would be controlled by a ballast system control (62). The faster assembly wheel (60) speed would yield a higher lift force for the individual unit up to the maximum speed. (Precession speed) The upward force on each corner unit would yield a resultant vector summation for the lift force location and magnitude. For steady or hovering elevation the vector summation is to be the exactly the same as the center of gravity for the entire craft. Two tilt sensors (61) at two locations, for each direction, are utilized.

Likewise the speed of the horizontal gyro assembly wheel (8) could be controlled (by a VFD (62)) for an increasing or decreasing horizontal force for the craft.

In FIG. 25, an alternate for the pulley arrangement is a gear to gear arrangement for turning the gyro unit for changing directional movement or for the assembly wheel drive system (See FIGS. 1 and 2) Typically one larger gear (95) and shaft (215) with one smaller gear (96) for the motors or gear motors (9, 17, 74, 116, or 213) would be required. The larger gear utilize bearings (220).

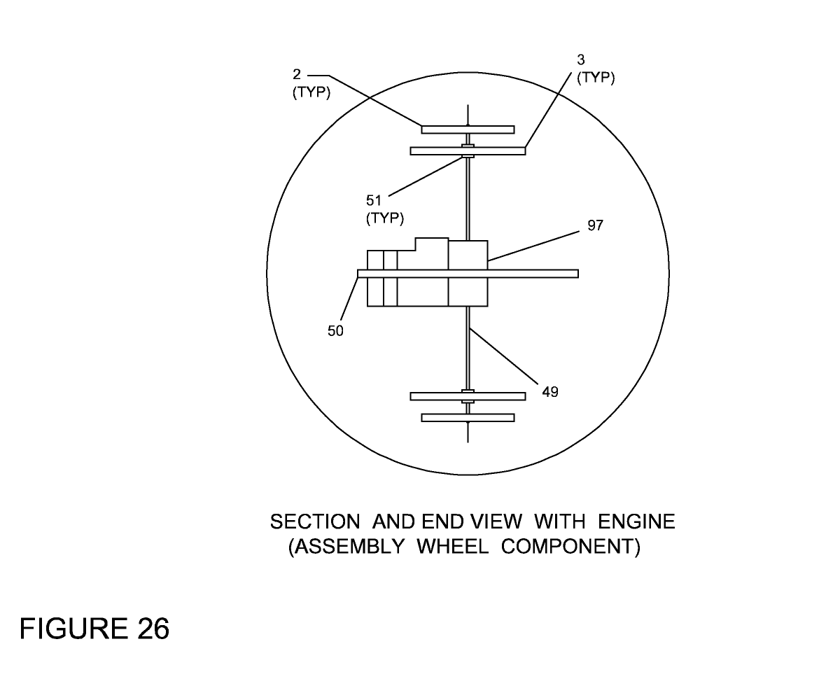

In FIG. 26, another alternate is a double ended engine driver (97) with a flywheel pair (2) and with a single long shaft (49) and bearings (51). The cross piece or framing support (50) that connects across to each disk (4) is shown. This holds the engine in position. This is an alternate for the Section A for FIG. 10. As mentioned previously, part numbers (2 and 3) are shown and identified.

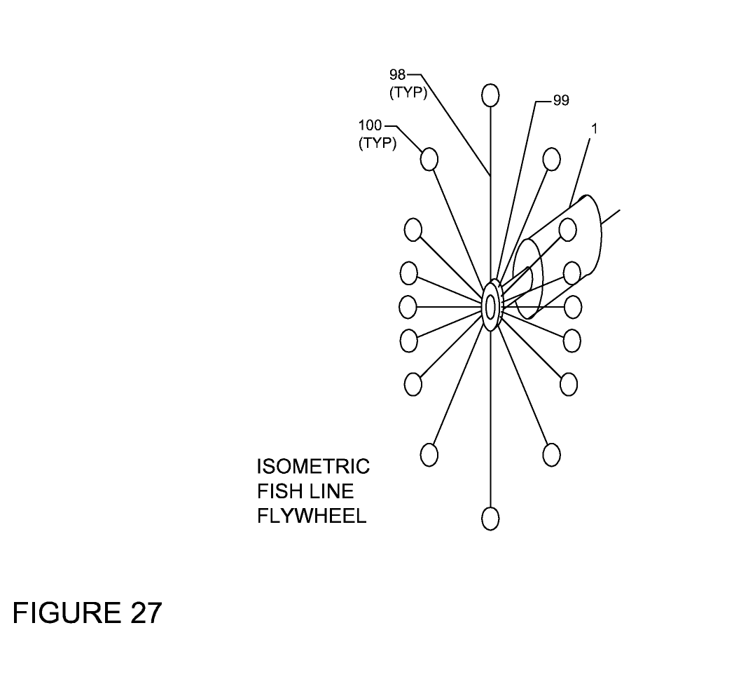

FIG. 27 illustrates an arrangement for smaller units wherein a flywheel that is composed of multiple fish line (98) extending from a hub (99) and spherical weights (100) attached to the fish line on the distal end from the hub. In combination with a flywheel motor (1), this would serve for the flywheel and motor.

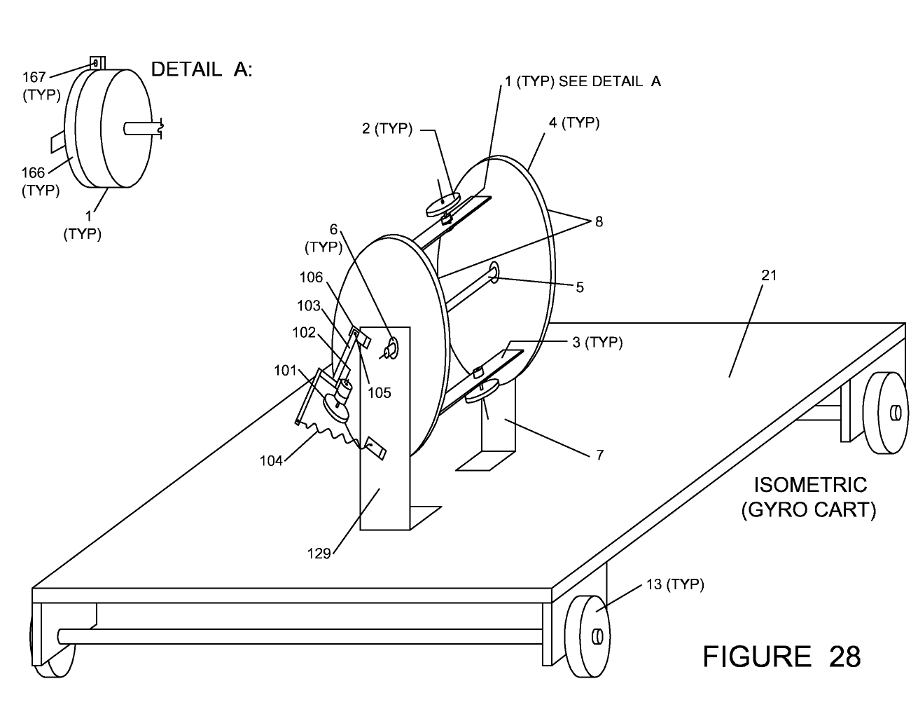

FIG. 28 illustrates another arrangement for small applications wherein a combination of rubber wheel drives (101) can be used. A motor (102) drives each rubber drive wheel. A lever (103) with spring (104) keeps the pressure on the disk assembly wheel (8). The lever is has a pin connection (105) at the bracket (106). Two rubber wheels (101) can be used one on each disk wheel or one on each side will effectively make the pressure force offset each other. Therefore, the effective force on the assembly wheel bearings (6) will be zero. Different positions on the lever (103) for the rubber wheel (101) are possible for different gear ratios, as the rubber wheel spot radius on the assembly wheel disk (4) is changed. For the Section A that is shown, refer back to FIG. 1 for typical electric motor driven flywheels unit. The unit support (129) is wider than the normal support (7) since it holds the bracket (106) and the unit bearing (6). Detail A shows the motor (1) with a clamp (166) and bolt (167). As mentioned previously, part numbers (2, 3, 5, 13, and 21) are shown and identified.

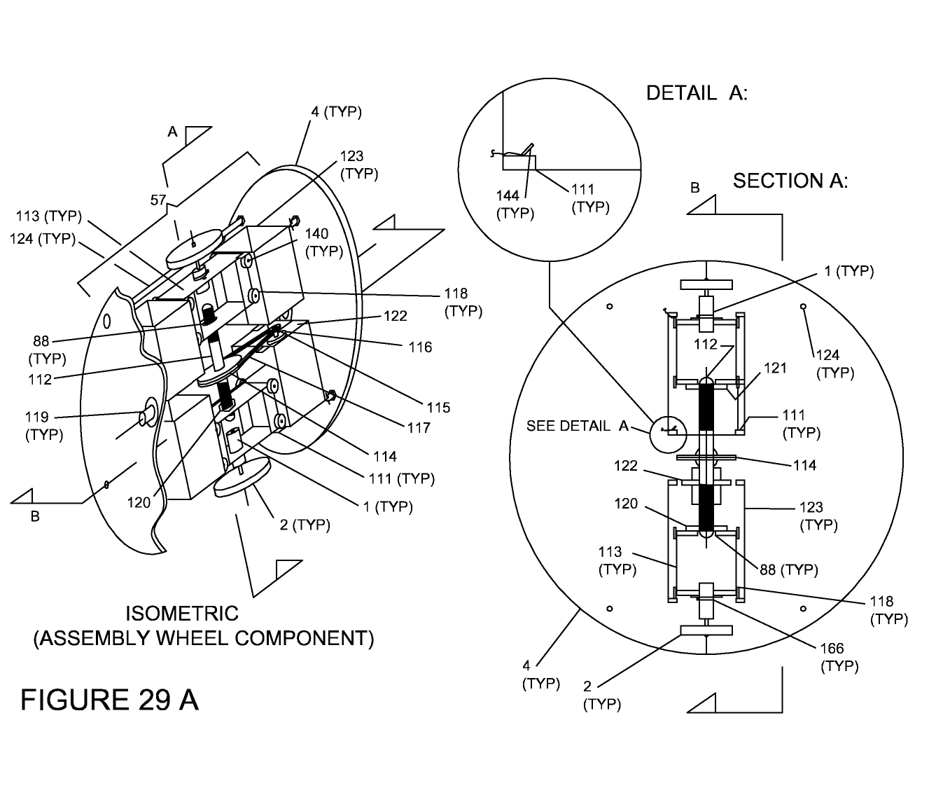

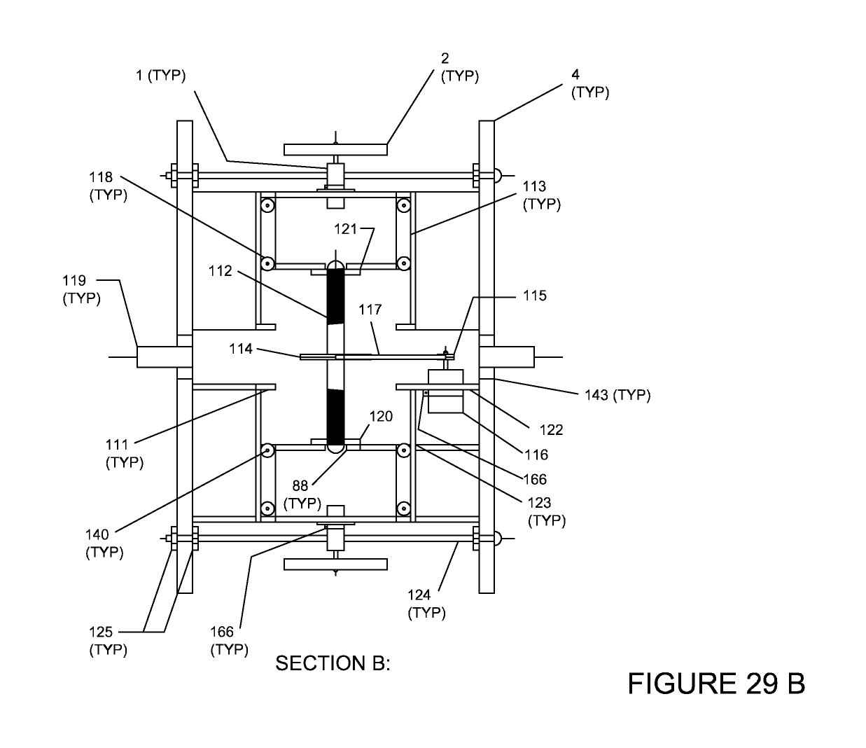

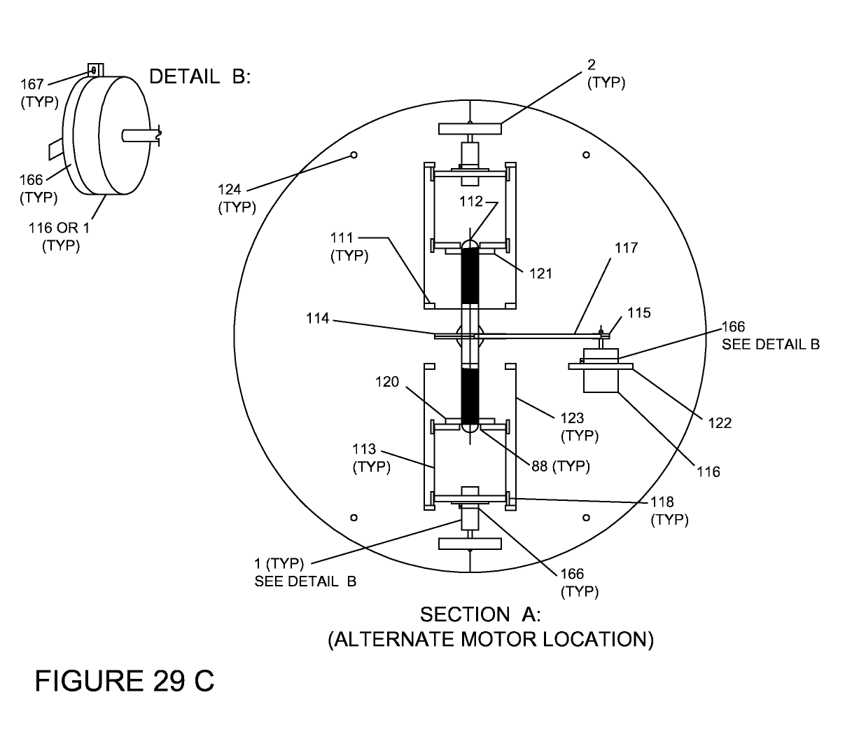

In FIGS. 29A, 29B and 29C, the cart is not shown for clarity. (Refer to other figures for the cart drawings.) For this design, moving the gyro electric motor (1) and flywheel (2) in and out of the two disk gyro assembly wheel (8) will change the radius and likewise the reaction force at a set speed of the unit and of the flywheels (2). Both flywheels (2) are to be moved identically or symmetrically to maintain a diametric arrangement of the gyro assembly wheel (8). A screw gear type shaft (112) with a left-handed screw gear threads on one side and a right handed threads screw gear on the opposite side will push the gyro flywheels (2) or pull them together, when it is rotated clockwise or counter clockwise. The screw gear shaft (112) is threaded to match each threaded plate (120 & 121) one plate is left handed (120) and the other opposite (121). These plates are shown as hexagons, similar to a regular nut. Attach these (120 & 121) to each frame (113). Each frame has a hole (88) for the gear screw drive shaft (112) to go through. A frame (113) that holds the flywheel (2) and motor (1) allows movement in and out. It has wheels (118) with shafts (140) that roll on a platform frame (123). The screw gear shaft (112) will be turned by a pulley arrangement. One large pulley (114) on the screw gear shaft (112) and one smaller pulley (115) on the reversible motor (116) connected by a belt (117). The motor (1) and flywheel (2) will be moved equally in or out. This motor (116) is attached to a mounting cross brace (122). Stops (111) and limit switches (144) will prevent the motor from running in one direction too far. Controls and electrical power will be routed thru the disk by utilizing bronze washer types rings and brushes, similar to part numbers 23, 24 or 25 as previously noted in FIG. 4 above. Controls (62) can be mounted on the craft framing. The four connecting rods (124) with double nuts (125) connect the two disks and maintain a proper pressure for the rollers to ride smoothly with proper alignment. Some adjustment will be required. Wood or plastic cross bracing is an alternate for the rods. The shorter shafts (119) do not run through to connect both disks (4). The shorter shafts (119) will connect to each disk by a flange or shoulder hub connection (143) to the disk (4). The hub (143) connects to the disk (4) perpendicular on both sides and makes the unit ready for the brackets that support the assembly wheel. There is one alternate location shown on Section B for the gear screw-drive motor (116), etc. (See FIG. 29C.) Only one limit switch (144) is required for each direction (in or out), since turning the screw drive motor off with the one switch (144) will allow the stopping position of each gyro flywheel to be identical. (See Detail A, FIG. 29A.) Controls will be needed for restarting the drive motor in the opposite direction for the next engagement after a limit switch has deactivated the drive motor. Detail B, FIG. 29C, shows a clamp (166) and bolt (167) to hold the motor (1) in position. The component (57) is stackable, as previously described, etc. for other units. The screw gear shaft motor (116) could be replaced with a gear reduction motor unit.

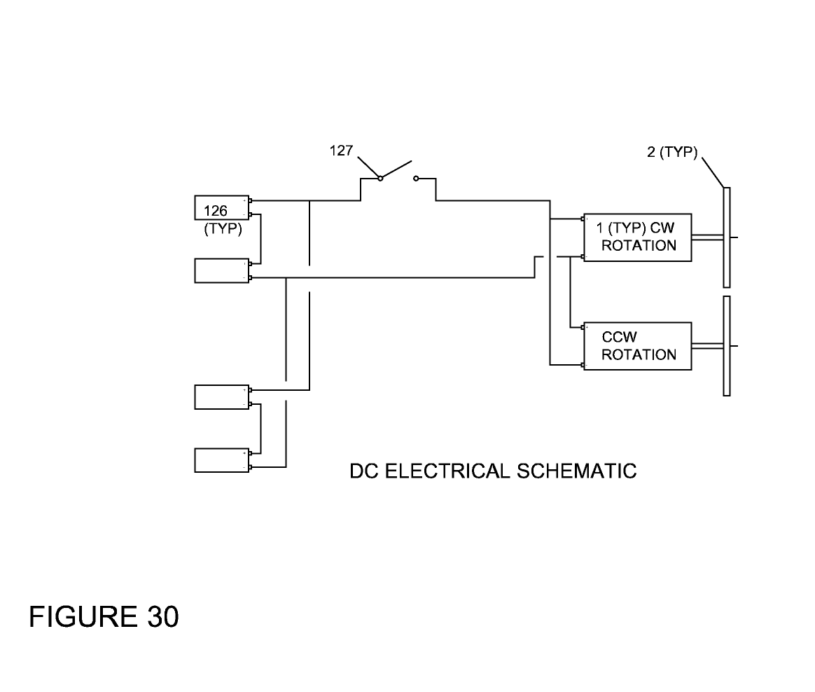

In FIG. 30, a wiring diagram for a 18 DC volt system for a toy model assembly wheel and cart unit is shown. Nine volt batteries (126) are wired in series with a on/off switch (127) using 18 VDC motors (1) with their flywheels (2). Note that the motors rotate opposite. One motor rotates counter clock wise, and one clock wise.

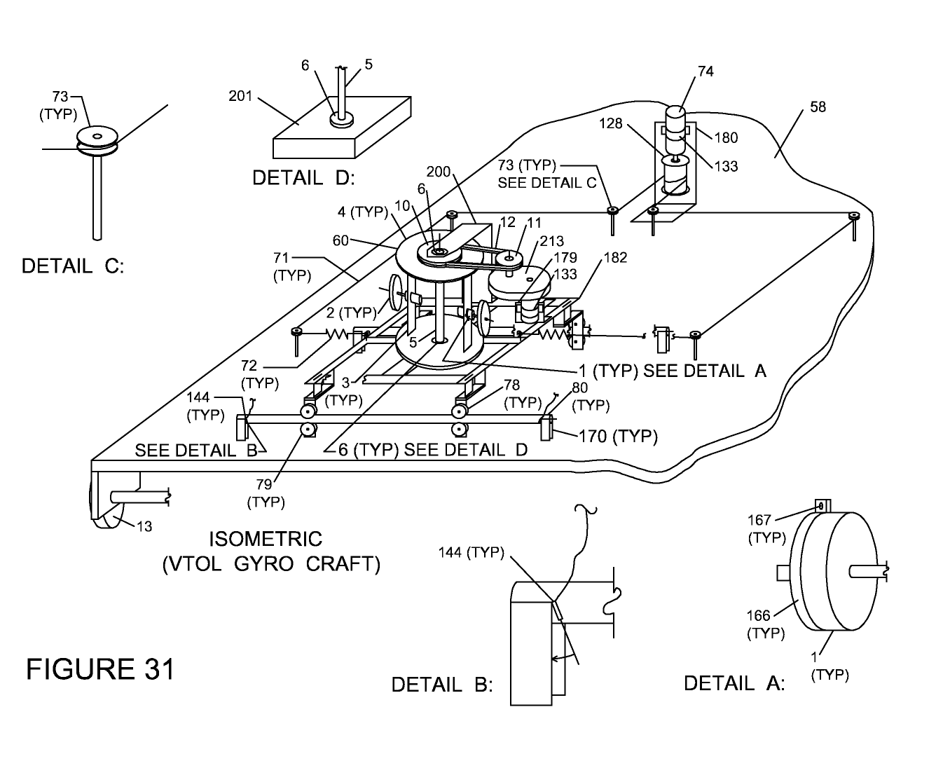

In FIG. 31, a new alternate for FIG. 22 shows an in line cable reel (128) and drive electric motor (74) unit in lieu of the reel drive unit described above FIG. 22. The cable is wrapped around the reel two revolutions for a friction grip. Special deep groove pulleys (73) keep the cable separated and feed the reel. (See DETAIL C.) The spacing will prevent misalignment when the reel is reversed, etc. There will be some vertical lift movement, for the cable is tracked when the reel is rotated, but the special deep groove pulleys (73) and the arrangement, as shown, should prevent the cable from slipping off. Special deep groove pulleys (73) will be positioned for spacing and cable routing as shown. The motion is restricted for one cycle and the reel width will be sized accordingly. The springs (72) will maintain the cable tension to prevent the cable from getting too loose. Detail A shows the motor (1) with a clamp (166) and bolt (167). The drive gear motor (213) is held in place by the mounting clamp (133). The drive gear motors (213) for the vertical lift gyro assembly units (60) are forward direction only. (CCW rotation looking from above the unit.) When the bottom roller (79) pushes against the limit switch (144), the motor (74) is stopped. (See DETAIL B.) Only one limit switch (144) is required for each direction (in or out), since turning the reel drive motor (74) off with the one switch (144) will allow the stopping position of each gyro flywheel to be identical for each side or each roller tube rail (80). Controls will be needed for restarting the drive motor (74) in the opposite direction for the next engagement after a limit switch has deactivated the drive motor. The motor (74) will be protected from overloading. This control system could be used in combination with other ballast weight systems or in lieu of a ballast system. A top support bracket (200) is included for the top bearings (6). The framing components include the additional parts (170, 179, 180, 182, and 201) that are shown and identified. DETAIL D shows a lift block (201) for the bottom support bearing (6) and shaft (5). This maintains a clearance for the bottom disk (4) and the framing (58). The drive motor (213) could be a standard full speed motor without gear reduction. The drive motor (213) effective rpm speed of the shaft output could be controlled by various methods for either the normal speed motor or the slower gear motor. As mentioned previously, part numbers (2, 3, 58, 71, and 78) are shown and identified. The reel motor (74) could be replaced with a gear reduction motor unit.

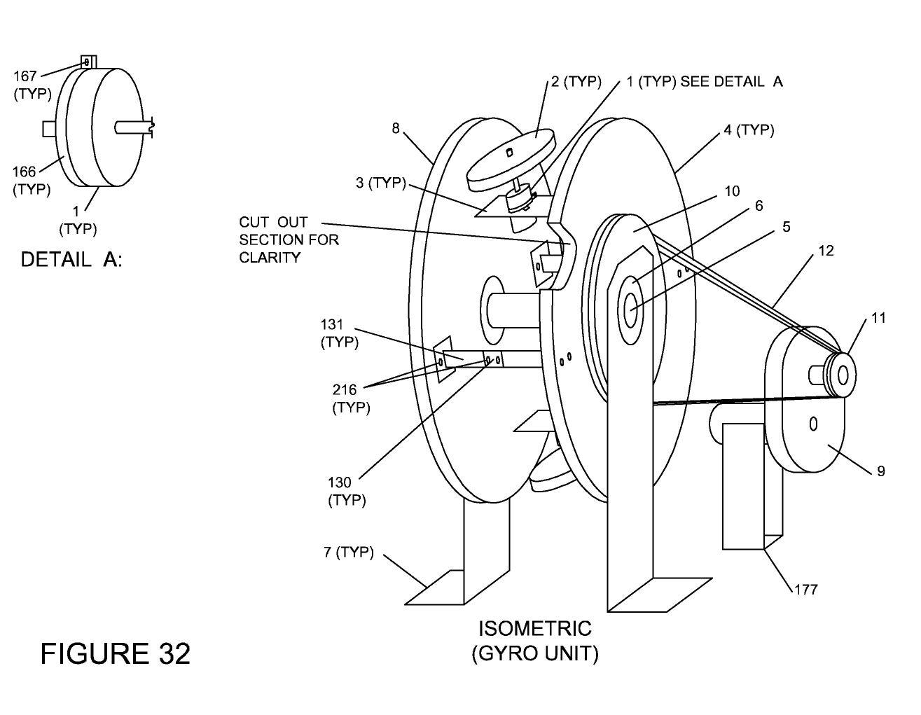

In FIG. 32, an alternate embodiment for single pair ground units (gyro assembly wheels) includes additional weights (130) mounted on the assembly wheel disk at 90 and 270 degrees. The weights (130) are held in place by rivets or bolts (216). This represents a 90 degrees rotational offset from the flywheel locations. A cross brace (131) is attached by rivets or bolts (216) to position the weights. A cut out section of the disk allows the matching component of the cross piece (131) to be shown. The cart is not shown for clarity. (Refer to other figures for the cart drawings.) Other arrangements are obvious. Detail A shows the motor (1) with a clamp (166) and bolt (167). The framing components include the additional parts (7 and 177) that are shown and identified. As mentioned previously, part numbers (2, 3, 4, 5, 6, 8, 9, 10, 11 and 12) are shown and identified.

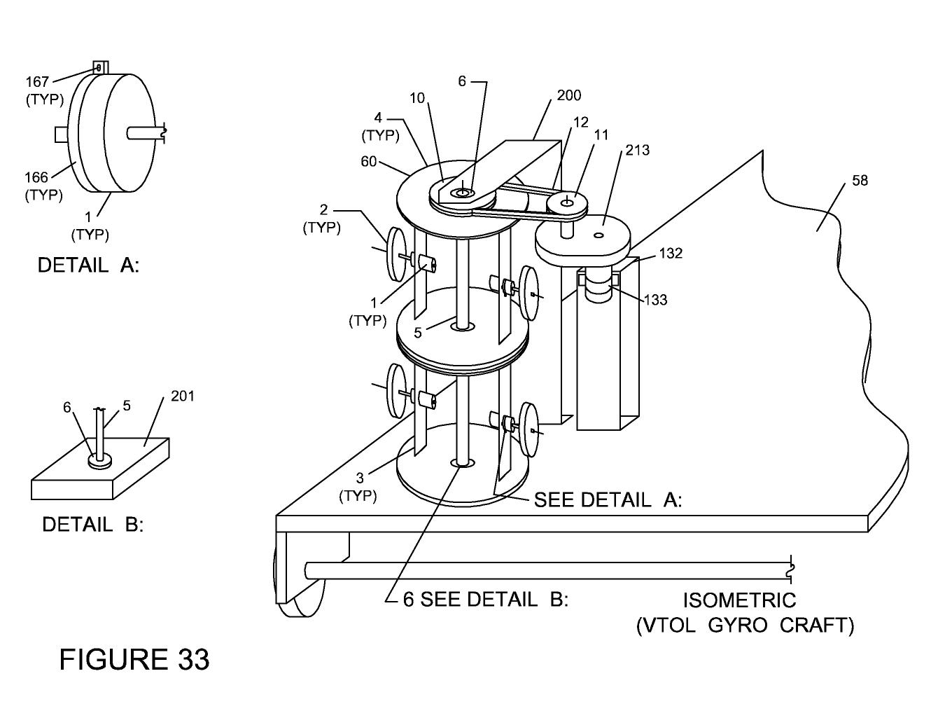

FIG. 33 shows multiple vertical lift gyro assemblies (60), mounted together forming a single unit, with one drive unit with gear motor (213), pulleys (10 and 11) and belts (12), and shaft (5) for the rotating unit. The drive gear motor (213) is attached to the stand and frame (132) by a clamp (133). One pair of gyro flywheels (2) is shown per gyro assembly. The stacking components include the disks (4) with the gyro motors (1) and flywheels (2) as a single pair mounted inside. Other figures that show the stacking horizontally is FIG. 1, FIG. 2 and FIG. 14. The drive gear motor (213) is held in place by the mounting clamp (133). The drive gear motors (213) for the vertical lift gyro assembly units (60) are forward direction only. (CCW rotation looking from above the unit.) A top support bracket (200) is shown for the top bearings (6). DETAIL B shows a lift block (201) for the bottom support bearing (6) and shaft (5). This maintains a clearance for the bottom disk (4) and the framing (58). Detail A shows the motor (1) with a clamp (166) and bolt (167). The drive motor (213) could be a standard full speed motor without gear reduction. The drive motor (213) effective rpm speed of the shaft output could be controlled by various methods for either the normal speed motor or the slower gear motor. The framing components include the additional parts (132 and 201) that are shown and identified. Part numbers (3 and 58) are previously shown and identified.

FIG. 34 shows the gyro unit (8). It shows two additional bearings (214) for each gyro flywheel shaft (183). This shaft (183) is connected to and drives the two flywheels (2), but on previous figures without additional bearings (214). For each flywheel (2) and shaft (183), the two cross brace supports (136) hold the two additional bearings (214) in position, one inside and one outside. (Four total bearings (214) for each flywheel pair.) The external shafts (183) are connected by two couplings (217) to the motor's shaft (137). If an extra long shaft from the motor (1) is used these two parts (183 and 217) would not be necessary. Detail A shows the motor (1) with a clamp (166) and bolt (167). The cart is not shown for clarity. (Refer to other figures for the cart drawings.) The framing components include the additional parts (7 and 177) that are shown and identified. As mentioned previously, part numbers (3, 4, 5, 6, 9, 10, 11, 12) are shown and identified.

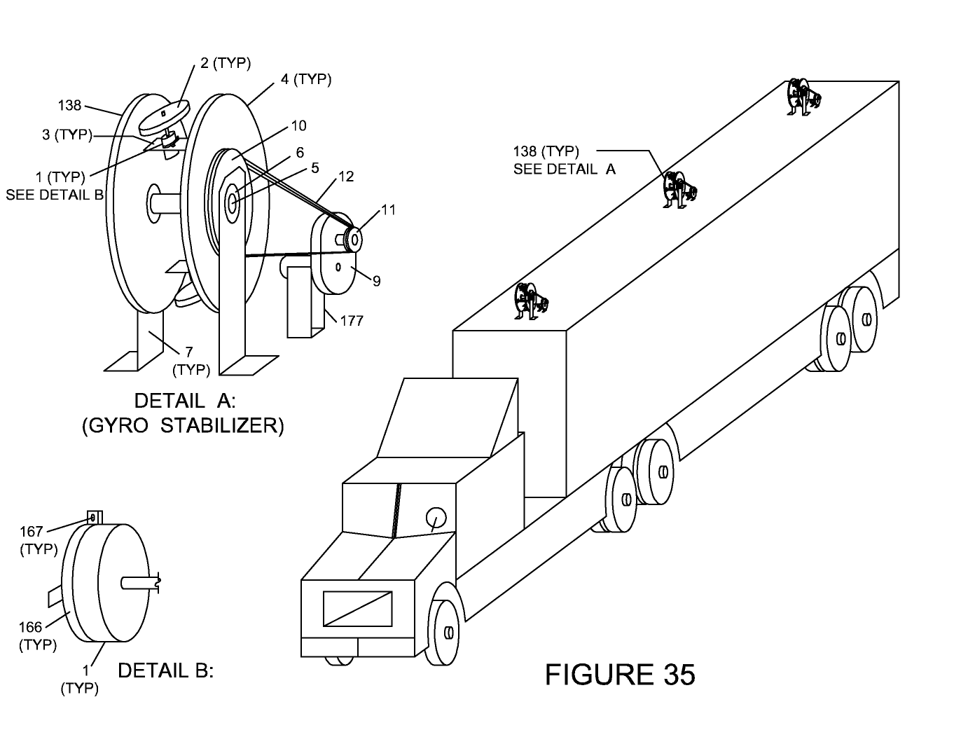

FIG. 35 shows three pusher/stabilizer type gyro force generating units (138). This would be electric driven motors or other types, such as PTO hydraulic driven motors. The three units sit on the top of the trailer, to provide a force opposite the turning centrifugal force that naturally occurs during highway turns for the tall trailer. This would provide a safer turning capacity for 18 wheel trucks for high speed travel. The gyro assembly drive motors will be reversible to provide left or right turn assistance for the tall and loaded trailer. Detail A is an enlarged isometric view of the gyro stabilizer unit. Detail B shows the motor (1) with a clamp (166) and bolt (167) to hold the motor (1) in position. The framing components include the additional parts (7 and 177) that are shown and identified. As mentioned previously, part numbers (2, 3, 4, 5, 6, 9, 10, 11, 12) are shown and identified.

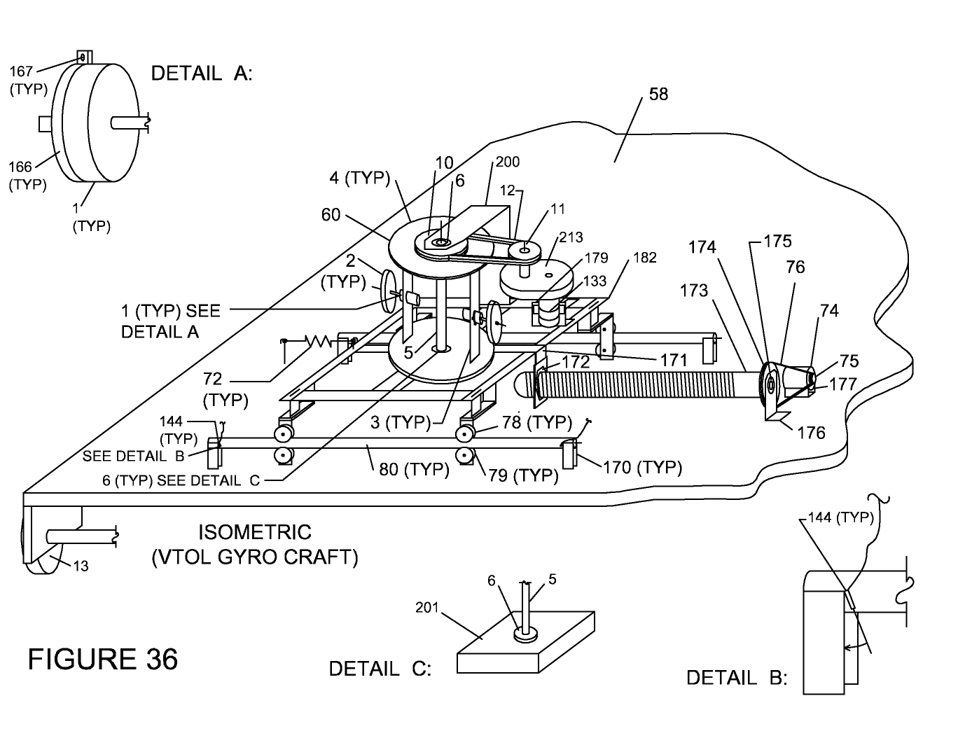

Referring to FIG. 36, to maintain level flight the vertical lift gyro assembly wheel units (60) can be moved in or out by a screw gear shaft (173). The screw gear (173) is driven by a motor (74) with a small pulley (75) and a belt (76). The larger pulley (174) is mounted on the screw gear (173). This will move the gyro assembly (60) smoothly. The motor (74) has a motor mounting support (177). Another support bracket (176) holds one end of the screw shaft (173) with bearings (175) on the drive end. The other end of the screw shaft (173) goes into the thin frame nut (172). This will allow the gyro assembly (60) to move in or out, when the screw shaft (173) is rotated clockwise or counter clockwise. This motor (74) could be a gear motor. When the bottom roller (79) pushes against the limit switch (144), the motor (74) is stopped. (See DETAIL B.) Only one limit switch (144) is required for each direction (in or out), since turning the screw drive motor (74) off with the one switch (144) will allow the stopping position of each gyro flywheel to be identical. Controls will be needed for restarting the drive motor (74) in the opposite direction for the next engagement after a limit switch has deactivated the drive motor. The motor (74) will be protected from overloading. This could be used in combination with other ballast weight systems or in lieu of a ballast system. Detail A shows the motor (1) with a clamp (166) and bolt (167) to hold the motor (1) in position. The drive gear motor (213) is held in place by the mounting clamp (133). The drive gear motors (213) for the vertical lift gyro assembly units (60) are for upward direction only. (CCW rotation looking from above the unit.) The framing components include the additional parts (170, 171, 179, 182 and 200) that are shown and identified. Also the gyro assembly speed could be controlled by the level flight and elevation controller (62). As mentioned previously, part numbers (1, 2, 3, 10, 11, 12, 13, 72, 78 and 80) are shown only. A top support bracket (200) is included for the top bearings (6). DETAIL C shows a lift block (201) for the bottom support bearing (6) and shaft (5). This maintains a clearance for the bottom disk (4) and the framing (58). The drive motor (213) could be a standard full speed motor without gear reduction. The drive motor (213) effective rpm speed of the shaft output could be controlled by various methods for either the normal speed motor or the slower gear motor. The screw drive motor (74) could be replaced with a gear reduction motor unit.

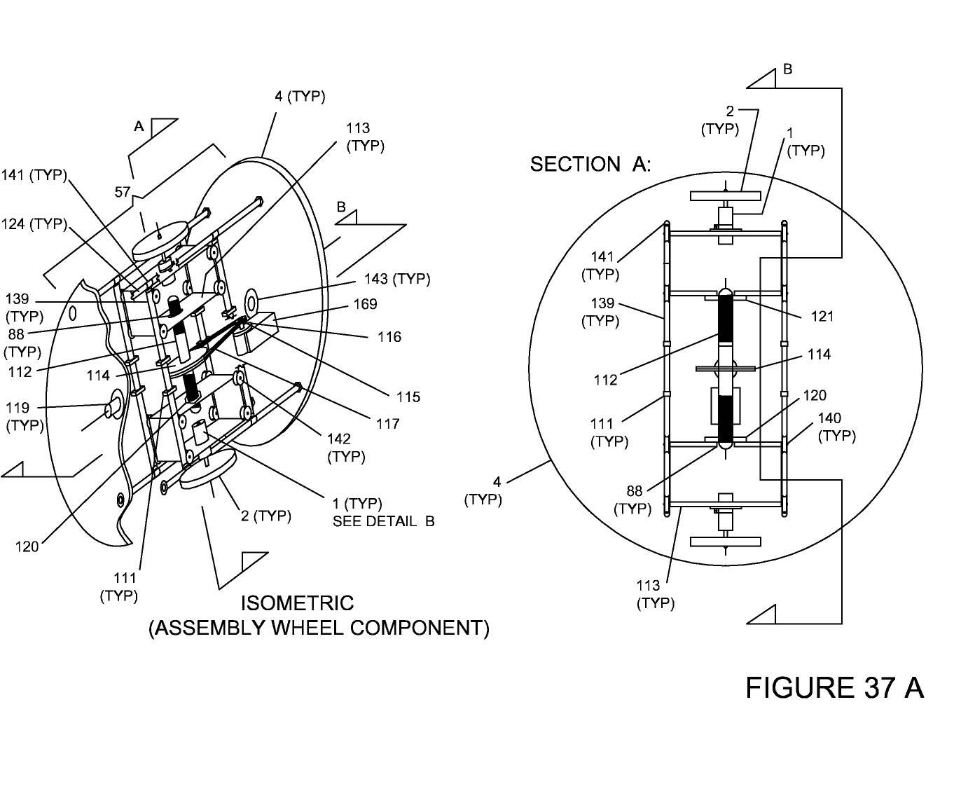

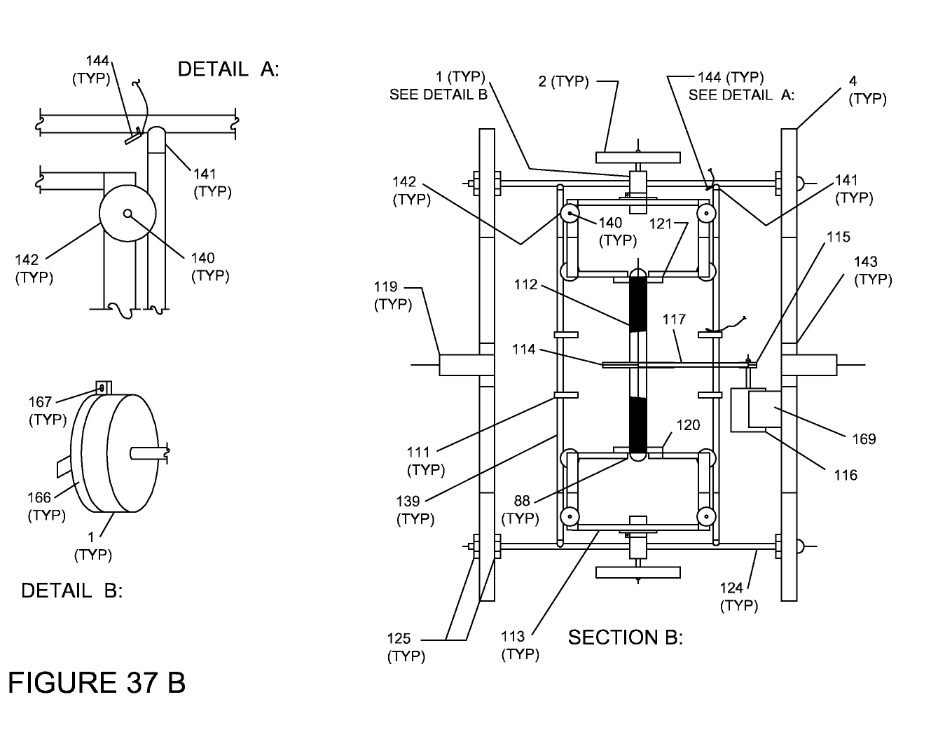

Referring to FIGS. 37A, 37B, and 37C, the cart is not shown for clarity. (Refer to other figures for the cart drawings.) The gyro electric motor (1) and flywheel (2) moves in or out of the two disk gyro assembly wheel and this will change the radius and likewise the reaction force. The gyro flywheels (2) are set at a constant speed. The assembly wheel rpm speed can be adjusted as normal. However, this system allows more adjustment for the total magnitude of the reaction force in addition to the assembly wheel rpm speed. Both flywheels (2) are to be moved identically or symmetrically to maintain a diametric arrangement of the gyro assembly wheel. A screw gear type shaft (112) with a left-handed screw gear on one end and a right handed screw gear on the opposite end will push the gyro flywheels (2) or pull them together, when it is rotated clockwise or counter clockwise. The screw gear shaft (112) is threaded to match each threaded plate (120 & 121) one plate is left handed (120) and the other opposite (121). These plates are shown as hexagons, similar to a regular nut. Attach these (120 & 121) to each frame (113). Each frame has a hole (88) for the gear screw drive shaft (112) to go through. A shorter shaft (119) for the assembly wheel is required on each disk (4). The shorter shafts (119) will connect to each disk by a hub or flange connection (143). The hub (143) connects to the disk (4) perpendicular on both sides and makes the unit ready for the brackets that support the assembly wheel. A frame (113) that houses or contains the flywheel (2) and motor (1) allows movement in and out. It has wheels (142) with shafts (140) that roll on a rod (139). The roller rods (139) are cylindrical and could be metal tubing (aluminum, bronze or stainless steel). There are a total of four roller rods (139) for the unit. In addition the roller rods (139) could be made of strong plastic or even wood. Each roller rod (139) has two tee connections (141), one on each end. The screw gear shaft (112) will be turned by a pulley arrangement. One large pulley (114) on the screw gear shaft (112) and one smaller pulley (115) on the reversible motor (116) connected by a belt (117). The motor (1) and flywheel (2) will be moved equally in or out. This makes a perfect gyro flywheel pair. This motor (116) is attached to a motor mount frame (169). Stops (111) and limit switches (144) will prevent the motor from running in one direction too far. The motor (116) will be protected from overloading. Controls and electrical power will be routed thru the disk by utilizing bronze washer types rings and brushes, similar to (23, 24 & 25) as previously noted in FIG. 4 above. Controls (62) can be mounted on the craft framing. The four connecting rods (124) with double nuts (125) connect the two disks and maintain a proper spacing and pressure for the rollers to ride smoothly with proper alignment. These rods (124) could be metal tubing, aluminum, brass or stainless steel. Some adjustment will be required. Wood or plastic cross bracing is an alternate for the connecting rods (124). Section B (FIG. 37B) is cut 90 degrees from Section A to show the frame (113), rollers (142) and motor (116).

Four roller rods (139) are used with four concave rollers (142) per gyro flywheel moving frame box (123). A tee adapter and connector (141) is utilized to attach the roller rods (139) to the disk connecting rods or spacers (124). Each roller wheel (142) has a shaft (140). The roller wheels (142) have a concave shape that fits the rods (139) and this will maintain the correction position and alignment as the gyro motor and flywheel move in and out and allow an easy in and out motion. A motor mount (169) keeps the motor (116) securely in position. A hub (143) is utilized for attaching the bearing to the disk (4) on each end. Each roller wheel (142) has a shaft (140). Only one limit switch (144) is required for each direction (in or out), since turning the screw drive motor (116) off with the one switch (144) will allow the stopping position of each gyro flywheel to be identical. Controls will be needed for restarting the drive motor (116) in the opposite direction for the next engagement after a limit switch has deactivated the drive motor. Detail B shows the motor (1) with a clamp (166) and bolt (167). The component (57) is stackable, as previously described, etc. for other units. The screw gear shaft motor (116) could be replaced with a gear motor unit.

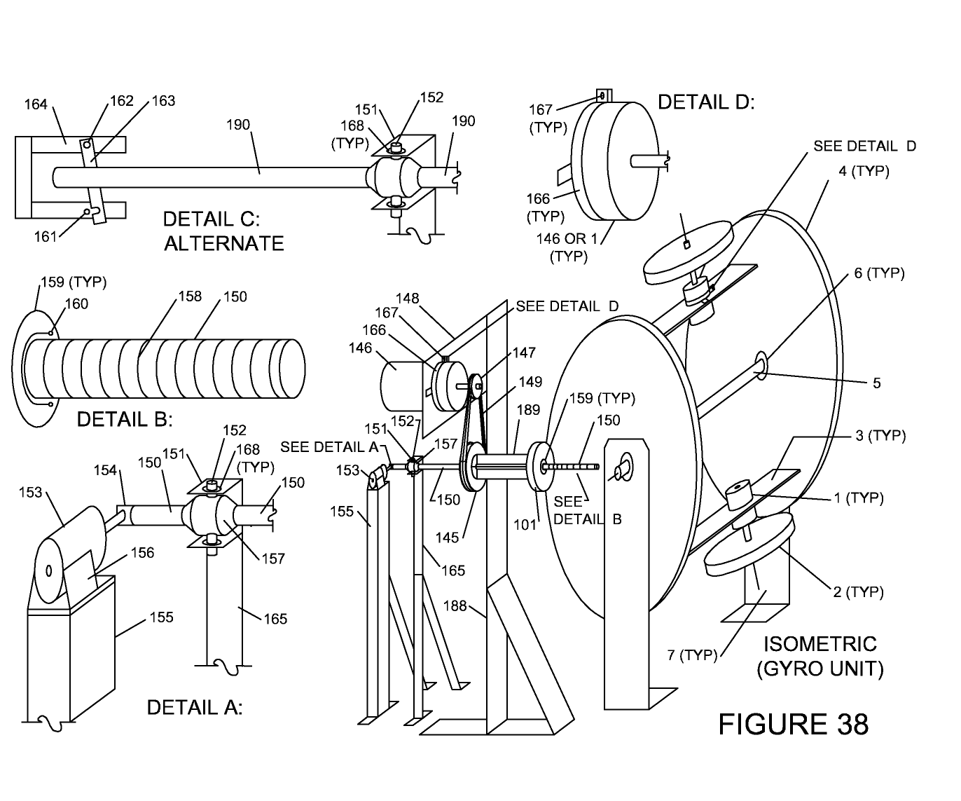

Referring to FIG. 38, the cart is not shown for clarity. (Refer to other figures for the cart drawings.) This figure illustrates another arrangement for small applications wherein a combination of rubber wheel drives (101) can be used. A drive motor (146) drives the rubber drive wheel (101) by a pulley system with a smaller pulley (147), a larger pulley (145) and a connecting belt (149). This drive motor (146) could be replaced with an optional gear reduction motor unit. An energized solenoid motor (153) keeps the rubber wheel (101) pressing upon the outer disk (4) of the assembly wheel. It is connected to the swivel/slide type joint (154), which is attached to the lever and shaft (150). The solenoid motor (153) will be used for a on/off position for the rubber drive wheel (101). The rubber wheel (101) is slightly compressible for good traction results with adequate applied pressure. A de-energized solenoid (153) will allow the internal spring to push out the connection point (154) and will move the lever (150) and therefore the rubber wheel (101) will be pulled away from the assembly wheel disk (4). (The solenoid motor (153) will have an internal spring.) The pin shaft connection (152) with a top and bottom bearing (168) is located in an enlarged joint section (157) of the lever rod (150). A framing support (188) for the drive motor is required to make a stand at the proper elevation with a cross piece (148) for the motor (146) support. Two rubber wheels (101) can be used one on each disk wheel (4) or one on each side will make the pressure force offset each other. Therefore, the effective force on the assembly wheel bearings (6) will be zero. Only one lever and rubber wheel mechanism is shown for clarity. Different positions on the lever (150) for the rubber wheel (101) are possible for different gear ratios, as the rubber wheel (101) contact and drive radius on the assembly wheel disk (4) is changed. The rubber wheel (101) and the larger pulley (145) are connected by a spacer (189) with a bearing (159) on each end. One bearing is for the pulley (145) and one for the rubber wheel (101). The lever shaft/arm (150) does not rotate. The connected and rotating spacer (189) allows the drive motor (146) and pulley (147) to be located at a reasonable position away from the disk (4). Alternate Detail C includes an alternate in lieu of the shorter lever arm (150) for a manual lever (190) with a latch bolt (161) with wing nut and a pin (162) with lever (163), to hold the engaged position of the rubber wheel (101). The arm length of the lever (190) is longer to facilitate an easier way to apply good pressure on the face of the disk (4). The Detail A is a enlarged drawing of the solenoid motor (153) and shows a bearing (168) for the pin shaft (152) for the joint (157). The bearing (168) and pin (152) are top and bottom to allow for a good swivel motion. Detail B is an enlarged drawing of the lever (150) showing the bearings (159), the snap ring retainer (160) and the shaft grooves (158). This arrangement allows the adjustment of both pulleys to move the same amount for the position adjustment so that the belt (149) remains in good alignment. Multiple grooves (158) are shown for the larger pulley (145) adjustment and rubber wheel (101) position. This will allow a different manual adjustment for the disk radius position. Two snap rings (160) are required, one for the pulley end (145) and one for the rubber wheel end (101). Also the drive motor or gyro motor (1 or 146) position is adjusted similarly by a motor clamp type support (166) and bolt (167). (See DETAIL D.) Arrange motor (146) in a position so that when the rubber drive wheel is engaged that the belt tension will be tight with good alignment. Therefore, both pulley and rubber wheel (145 & 147) and belt (149) will be positioned at the proper belt tension. The speed of the assembly wheel (8) will be changed, since there is a different gear ratio for each radius position on the face of the disk (4). Alternately the rpm speed of the drive motor (146) could be changed by a VFD (variable frequency drive) control system. The Detail D is a enlarged drawing of the drive motor (146) and clamp (166) with bolt (167) which allows the drive motor (146) to move in or out for the speed adjustment as per above. When two mechanisms with two rubber wheels (101) and two drive motors (146), the drive motors (146) could be one half the size of a single drive motor (146), since the application is additive for each motor (1 or 146). One drive motor (146) is clockwise and the other one is counterclockwise with the motor leads reversed. The framing components include the additional parts (151, 155, 156, 164, and 165) that are shown and identified. As mentioned previously, part numbers (1, 2, 3 and 5) are shown and identified. This system could be easily automated further with a splined shaft in replacement of the grooves (158) on the shaft (150) for the rubber wheel (101) and the larger pulley (145) and for the motor mount (148 and 166) also, with a lever mechanism for moving these components.

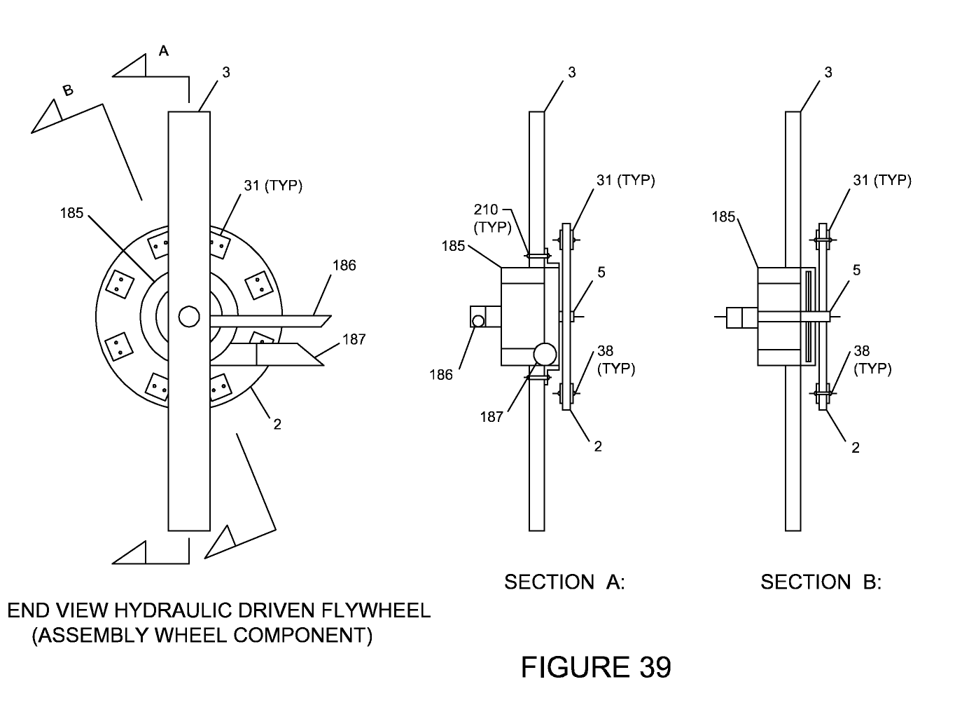

In FIG. 39, a hydraulic motor drive system is an alternate drive for the flywheels. A hydraulic motor (185) is used with two pipes, the inlet (186) and the outlet (187). The outlet (187) is piped to the return system. The inlet (186) is connected to the supply pressure piping. A swivel joint (26) is used for both the supply and return of hydraulic fluid. See FIG. 5 for the swivel joint piping with parts (26, 27, 28 and 109) shown. A pipe connection to a hollow shaft (27) is used for both connections, one on each end of the assembly wheel through the hollow shaft (27) to the inside of the gyro assembly unit for hydraulic fluid supply and return flow. Two short hollow shafts (27) with hub connections (143) are used, one on each end of the assembly wheel unit. (See FIG. 37B) Attachment hardware includes bolts or rivets (38 and 210). As mentioned previously part numbers (2, 3, 5 and 31) are shown and identified.

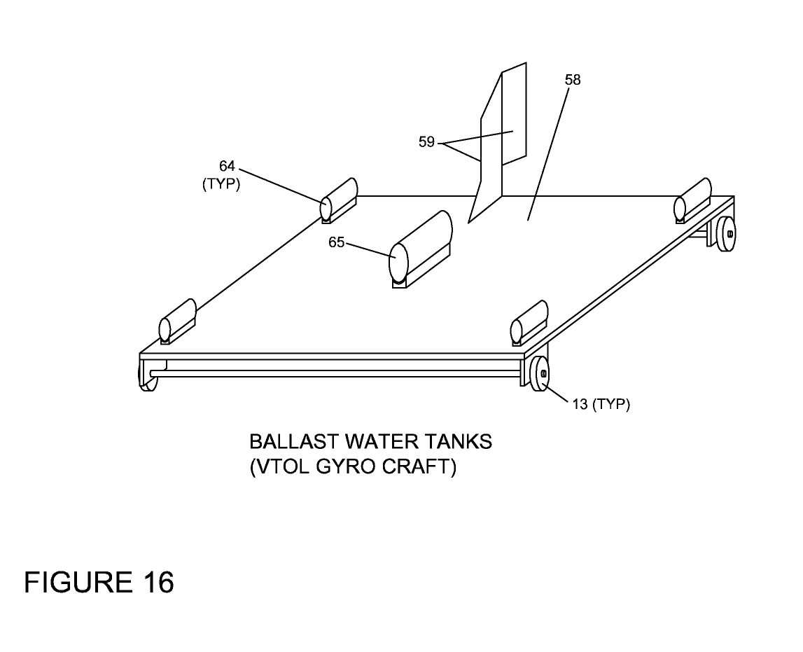

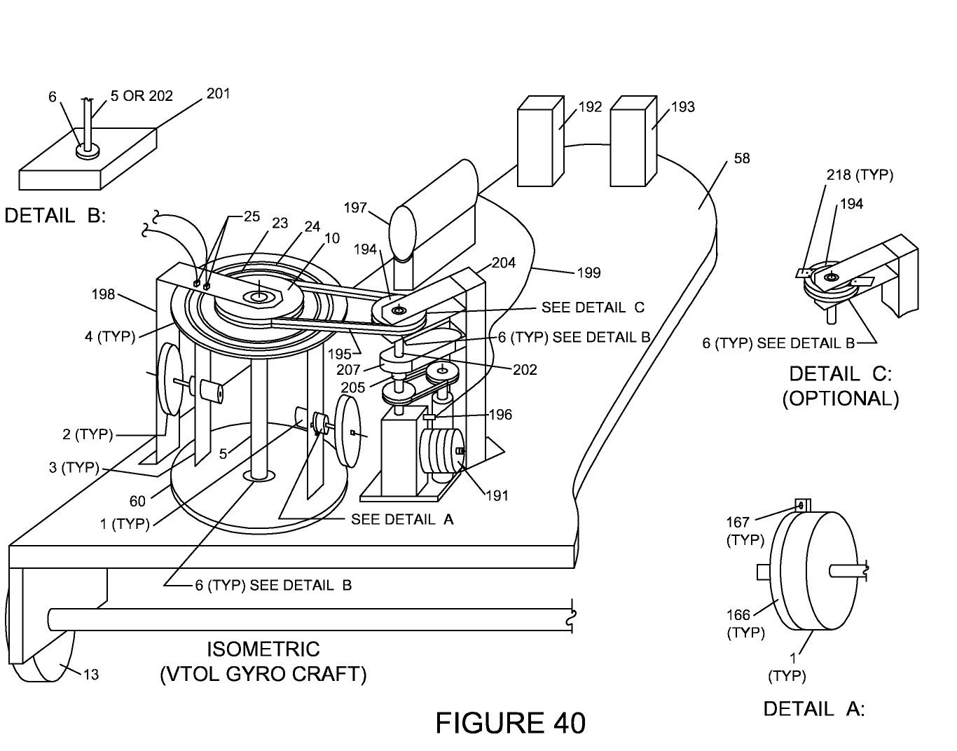

The FIG. 40 includes an onboard engine/generator unit (191). The glow plug type typical UAV engine (191) is utilized as a direct driver for the assembly wheel (60) and also for the on board generator component. Each assembly wheel unit (60) is provided with an engine and generator set (191), therefore each of the interior flywheel DC motors (1) is powered with the generator (191) and battery storage system (192). These can be banked into a common battery system or kept separate for each gyro assembly wheel unit (60). Each generator system (191) includes a control module (193) for the electrical output, etc. The engine generator set (191) is an off the shelf package. The driver includes a smaller pulley (194) mounted in place of a propeller for a typical off the shelf UAV engine, and is connected by a belt (195) to the larger pulley (10) for the assembly wheel (60). The gear reduction box (207) is mounted on to the framing support bracket (204) in between the top pulley (194) with its shaft (202) and the UAV engine. It is provided with the adapter (205) to connect to the engine shaft. Therefore the speed of the engine affects the upward force, and a central controller (62) will change the fuel throttle valve system (196) for each engine to maintain level flight by increasing some engine rpm speeds and decreasing others, similar to the VFD controller. These throttle valves (196) could be either for carburetors or for fuel injection systems. The fuel tank (197) is shown for each gyro assembly engine unit. The fuel line (199) connects the fuel tank (197) to the engine. The fuel tank (197) for each could be mounted on the outside craft edge and could be interconnected with a central fuel tank and used for ballast control in addition to storing fuel. The central fuel tank could be mounted in the center of the craft platform. (See FIGS. 16 & 17 for the pumping system, etc.) The bronze brushes (25) with soft springs allow the current to pass though the bronze rings (23 & 24) to the gyro flywheel motors (1). (See FIG. 4.) Therefore the current enters and provides power, AC or DC. The generator (191) and controller (193) for this case provides DC current and provide charging for the battery system (192), and thus a constant voltage is supplied by the battery system (192) to the internal gyro flywheel motors (1) for a constant rpm speed. Thus, the battery system (192) is kept charged. A top support bracket (198) is included for the top bearings (6) and for the brushes (25). The compound frame (204) holds another shaft (202) and two bearings (6), one for the top and one for the bottom for the engine drive pulley (194). The smaller drive pulley (194) drives the larger unit pulley (10) utilizing the belt (195). The gear reduction box (207) has the input shaft and adapter (205) and an output shaft (202). The input shaft connects to a customized adapter (205) to match the propeller hub mounting bolt pattern. DETAIL A shows the motor (1) with a clamp (166) and bolt (167).DETAIL B shows lift blocks (201) for the bottom support bearing (6) and shaft (5 or 202). This maintains a clearance for the bottom disk (4) and the framing (58) or other surfaces. DETAIL C shows an alternate arrangement with drive pulley (194) with a small fan blade set (218) mounted. This will provide cooling for the cylinder head of the UAV engine (191). The engine head could otherwise be provided with a small DC electrical fan applied directed to the engine head for cooling, since hovering maneuvers would not have any air flow over the engine head and cooling air flow will be required. As mentioned previously, part numbers (2, 3, 4 and 13) are shown and identified.

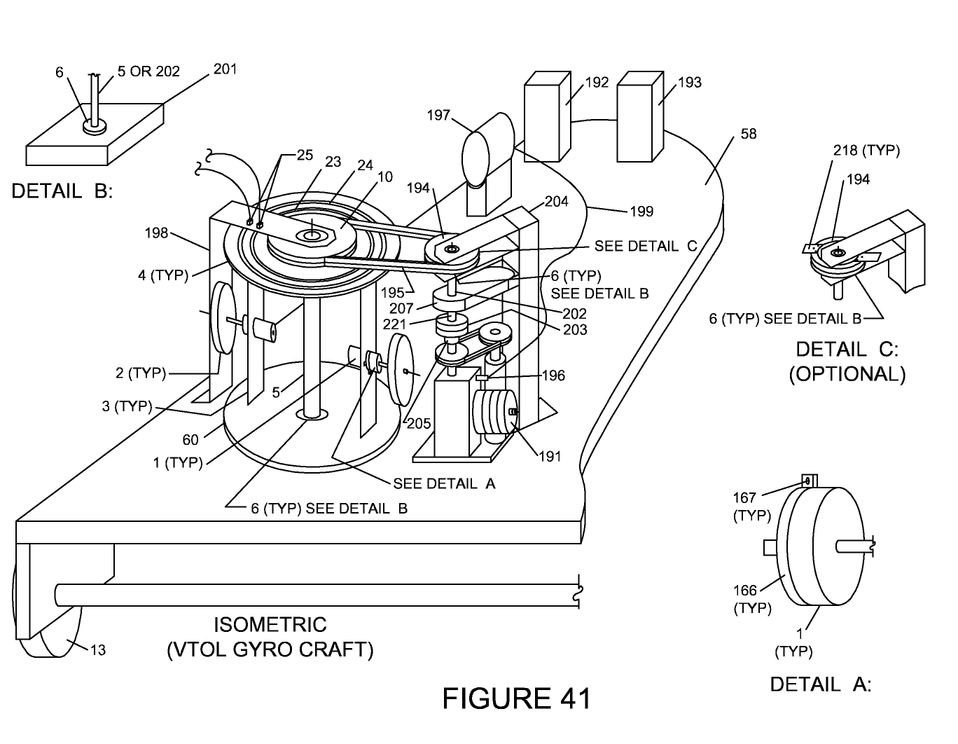

The FIG. 41 includes an onboard generator unit (191) very similar to the above FIG. 40. However, the unit utilizes a magnetic coupling (203). The smaller drive pulley (194) drives the larger pulley (10) utilizing the belt (195). The magnetic coupling (203) is utilized for rpm speed control, since the smaller UAV engines will be constant speed in most cases. It connects the engine shaft with the gear reduction bottom shaft (221). An adapter (205) is shown for mounting the magnetic coupling (203) to the standard propeller shaft of the UAV 2 cycle engine (191). DETAIL A shows the motor (1) with a clamp (166) and bolt (167). The DETAIL B show lift blocks (201) for the bottom support bearing (6) and shafts (5 or 202) utilized both for the assembly wheel unit (60) and for the upper drive pulley (194). The framing components include the additional parts (198, 201 and 204) that are shown and identified. As mentioned previously, part numbers (1, 2, 3, 4, 13, 23, 24, 25, 58, 192, 193, 196, 197, 199 and 218) are shown and identified.

FIG. 42 shows the alternate FIG. 3 components (57) stacked for the multi-row type gyro assemblies. The gyro flywheels are lined up since the angular positioning already includes an inherently balanced assembly wheel. The angular positioning and rotation order is important and is described elsewhere. Detail A shows the motor (1) with a clamp (166) and bolt (167). The framing components include the additional parts (7 and 177) that are shown and identified. As mentioned previously part numbers (2, 3, 4, 5, 6, 8, 9, 10, 11, 12, 13 and 21) are shown and identified.

For any of the assembly wheel units FIG. 1, 2, 10, 11, 13, 14, 18, 22, 23, 24, 28, 31, 32, 33, 34, 35, 36, 38, 40, 41 or 42) a control system could control the speed of the internal dc or ac gyro flywheel motors (1) by controlling the feeder voltage, frequency or the current flux. Likewise the internal gyro flywheel turbines (32) or hydraulic motor unit (185) (see FIGS. 7 and 39) could utilize the difference in pressure or flow for speed control. Likewise the internal engine driven flywheel units, parts (29 and 97), could control the fuel flow (see FIGS. 6 and 26). Other control systems demonstrated for the internal gyros are the variable radius options (see FIGS. 29 and 37). Due the equations both these methods will serve to modulate the result force. These options could possibly allow a constant speed drive motor system for parts (9, 102, 146, 191 and 213).

For all of the above figures that include the gear motors part numbers (9, 17 or 213), any of them could be replaced with a standard full speed motor, and any gear reduction would be done by gears or pulleys. The effective rpm speed of the shaft output could be controlled by various methods, such as VFD, for either the normal speed motor or the slower gear motor. Likewise the standard motors (74, 116 or 146) could be replaced with gear motor units.

Material of construction: The metal parts could be the shafts, pulleys, flywheel weights, threaded plates, gear screw shaft, reels, springs, bolts and nuts, tire rims, and others. For flight applications much more strenuous designs will be required to insure total weight is keep to a minimum. For flight, many plastic parts could be utilized that are normally metal. Other parts could also be light weight plastic or wood. Motors, engines, controllers could be normal shelf items.

The gyro motion unit comprises the following variations and illustrative embodiments. These and other embodiments will be apparent to those skilled in the art based on the detailed description provided.

In one embodiment, a disk assembly has a pair of opposing flywheels and said flywheels rotating about a first longitudinal axis. First and second motors are provided and the flywheels rotate as if rotating on the same shaft. (See FIG. 1)

First motors connect to each flywheel for separate rotation of each flywheel, wherein in each disk assembly one flywheel is opposed in rotation from the other when looking from the outside towards the center of the unit; or as noted above on the same single axis. First and second motors are provided. (See FIG. 1)

Next a unit assembly is provided comprising at least one disk assembly component and being rotatable about a second axis. A third electric motor unit is provided, which could be either a gear motor unit or a standard motor unit. The drive motor unit could be a variable speed motor, to control the total reaction force, which would control the total “Reaction Force” for each gyro assembly unit. This would control the forward speed of the craft, or the altitude, etc. A variable frequency drive “VFD” system would be used to control the speed of the drive motor unit, the third motor unit. (See FIGS. 1 & 15)

The drive motor, third motor, connects to the unit gyro assembly for rotation of the unit gyro assembly. This drive system is for the main useable “Reaction Force” to push the entire unit forward, etc. This utilizes the principle of a reaction force for moving an energized gyro flywheel, but the assembly wheel makes it mechanized and it is continual. (See the discussion of the precession speed, elsewhere.) A pair of gyro flywheels is utilized for a perfect dynamic weight balance of each gyro assembly unit and is required for the reaction force. (See FIG. 1). A further discovery during experimentation is that three gyro flywheels mounted in the assembly wheel will not produce the reaction force desired. This is the reason that the gyro flywheels are shown as pairs in all of these designs. Also a specific rotation for each pair is required.

The first arrangement of multiple flywheel pairs is simple. The components with the gyro flywheel pairs will be lined up and would all have the same rotation. The 0 degree flywheels would be CCW and the 180 degree flywheels would be CW in all the components. The assembly wheel with multiple rows (lined up rows) will have an additive reaction force for each pair. (See FIG. 1)

Second is a staggered pair arrangement. The specific rotation for staggered multiple pairs is essentially the same for two cases. The arrangement could be multiple components stacked as rows. (Very similar to FIG. 1.) Or the arrangement could be a single component with a larger radius with multiple gyro flywheel pairs. (See FIG. 3.) As the gyro flywheel pairs are numbered as per the rotation of the assembly wheel, CCW. Then the first gyro would be CCW rotation. Then each sequential flywheel would be CCW, such as 0 degrees, 45 degrees, 90 degrees and 135 degrees. Then the next flywheel would be an opposite pair of one of the above, so the rotation would be CW for the flywheel at the position of 180 degrees, 225 degrees, 270 degrees, and 315 degrees. Therefore, the assembly wheel will have an additive reaction force for each of the multiple staggered pairs. Therefore the gyro pairs could be stacked and staggered in a row or staggered inside a single component. (See FIG. 42.)

An alternate to the VFD control system is a magnetic drive coupling to control the speed of assembly wheel unit driven by the unit drive constant speed motor, third motor. (See FIG. 12)

One simple power system is on board batteries or fuel tanks inside the gyro assembly for the flywheels. The unit will utilize exterior fuel tanks or batteries for the other motors and for the other power needs. (See FIGS. 6, 30, 40 and 41)

A power delivery system will provide input power for rotation of the flywheels and the unit assembly in lieu of on board batteries or fuel tanks inside the gyro assembly. Several power delivery systems and variations include: a Fuel delivery system with a swivel joint and a hollow shaft through the disk of the assembly wheel (See FIG. 5); an electric deliver system with brushes and rings on the flywheel for a normal higher voltage AC system (See FIG. 4); likewise the external motors (part no. 9, etc.) could be normal higher voltage AC systems. (A generator could be utilized as well for a DC system.)

An alternate design in lieu of separate gyro motors and flywheels above is a single double ended motor, first motor, with a single crossing shaft or axle. The shaft would connect across the two flywheels to energize the pair. Proper flywheel rotation would be achieved automatically, and one of the flywheel motors is eliminated.) (See FIG. 10)

In addition the single shaft or axle above can be connected by a power driven gear or pulley and driven by the first motor and the second motor is eliminated. (See FIG. 11)

Another steering motor connection to the gyro assembly frame is geared down with controlled rotation and for angular directional positioning of the unit, wherein a fourth motor unit is provided. This will rotate/turn the gyro assembly unit frame and likewise the “Reaction Force” will turn and very effectively provide steering for the craft. (See FIG. 2) This unit could be a gear motor unit or a standard motor unit.

Power can be fed into the rotating assembly for the gyro flywheel motors, in lieu of batteries for each motor. This can be done by a special brush and spring unit for both the positive and negative connections. Wiring each motor opposite is then accomplished. The power feeder rotating connection consists of two separate rings, one larger in diameter. The rings are mounted onto the disk on one side. With first and second motors arranged accordingly, a brush set would make contact to each ring of the leads, negative and positive similar to motor armature brush set, except flat rings like washers, suitable for the disk flat surface. (See FIG. 4)

An alternate design of above would have one ring with brush and spring on one disk and the other ring, etc. on the other disk at the opposite end. These could use the same size rings.

Reversing motors could be used for applying brakes to the unit while in a forward motion for ground vehicles, aircraft or marine units, wherein a third motor is used. When the assembly drive motor is reversed in direction from CCW to CW, the “Reaction Force” would be reversed in direction. (See FIG. 1)

All motors could be variable speed for control starting with the assembly drive motor, third motor, then the steering motor, fourth motor, etc. then the gyro flywheel motors, first and second motors. It is expected that the gyro flywheel motors, first and second motors, would only be constant speed in most all design cases. The drive motor, the third motor, speed would control the magnitude of the total forward force. Careful designs will be required to insure no tumbling for aircraft, etc. An elevation or altitude sensor as well as two tilting sensors will connect into a central controller for the crafts so that each gyro assembly wheel will be controlled. Banking for turning could be made by the controller. Descending and ascending would be controlled. An optional rudder would be controlled manually by a normal mechanism. But the stabilizing gyro, which is similar to the helicopter stabilizer rotor, would be connected to the central controller. Craft rotational inertial sensors are required. Manual flight adjustments for trim control would be made to the central controller by the pilot. (See FIGS. 14 and 15)

In another embodiment, smaller gyro assemblies could be used to counteract the torque tendencies or for the friction of the bearings which would turn the entire craft. The framing of the craft receives the torque or turning effect. The reaction provided is similar in purpose to a helicopter's tail rotor to counteract the main rotor torque effect. (See FIG. 15.) The gyro assembly speed controller shown in FIG. 15 could be adjusted for ballast control for level flight.

In another embodiment, smaller gyro assemblies could be used to counteract the overturning force of high speed truck trailers. These could be electrically powered or some PTO (power take off mechanism) developed later. (See FIG. 35.)

In lieu of the electric motors, regular combustion engines could be utilized. The two gyro flywheel motors and the drive motor could be replaced with combustion engines for power. These could be variable speed or constant speed. It is expected that the speed for the gyro flywheels would remain constant. For a pair of gyro flywheels, one engine would rotate CCW and the other CW. Small 2 cycle model airplane engines do this now without any problems, and so larger ones could be built. It is expected that the steering motors, i.e. the fourth engine driver, would remain electric. (See FIG. 6)

Larger UAV (Unmanned Aerial Vehicle) 2 cycle engines now can be ordered with CCW and CW rotations. These engines are operated now at constant speed, set after start up. These UAV engine/generator units could be utilized as the drive units for VTOL onboard generators and for VTOL assembly wheel drive units in combination with gear reducers. (See FIGS. 40 and 41.) The dc generator drives the gyro flywheel dc motors and charges a battery system. On board fuel tanks can be utilized for a ballast systems and serve a double function.

A fuel swivel joint connection system at the disk on the assembly wheel can be used for the fuel connection to the gyro engines as per above and power the first and second engine drivers. (See FIG. 5)

Due to the weight verses power output the 2 cycle engines are inherently more suitable for this air craft application, and other benefits are discussed below.

In the future larger 2 cycle engines could be developed that run slower, and could be utilized for the drive system for the gyro assembly wheel unit. Any position for mounting is possible since the oil and gas are mixed. This would help with the gear reduction needed.

In the future other standard or higher speed 2 cycle engines could be developed to be utilized inside the assembly wheel, which will be rotating at the rpm speeds needed, but normally constant speed. The 2 cycle engines could run and be mounted on a disk wheel that is rotating. (See FIG. 6.) This is possible since the oil and gas are mixed, and the fuel is supplied by the special designs. A fuel pump may be needed, and could be any inline type connected to an exterior fuel tank system. For interior mounted fuel tanks the centrifugal force will provide adequate force for fuel delivery. Special design for the delivery line exit point is an easy modification for the interior tanks, similar to existing model airplane tanks used on circular line models. Fuel tanks can be pressurized by the vent line from an exhaust muffler. Fuel pumps can also be provided.

The gyro flywheels could be energized or powered by a turbine. The turbine for comprising the first and second turbine engine drivers for the flywheel pair could be vacuum, steam and condensate, or positive air pressure driven. (See FIG. 7) Similarly, the hydraulic motor drive is also shown and described. (See FIG. 39)

Spherical rollers for the flywheels would allow the flywheels to be a very large size for the lift required for air craft. The spherical roller prevents excessive wobble for the large size flywheels. The roller assembly connects to the flywheel by tube and piston with springs inside. The rollers are to ride in a trough hoop that is larger than the flywheel that is mounted to the assembly disk as a guide for the spinning flywheels. The rollers weight act as weight for the flywheel, so that the total rotational inertial would be adjusted for the added weight and radius. The weights of the flywheel could be reduced for this design, since the rollers are accumulative for the total flywheel rotational inertia weight. Therefore calculation to determine the amount, size and flywheel weights will be required. The flywheel weights may be eliminated by careful design. This should benefit the total system. (See FIG. 9)

Several alternate methods are considered in the embodiments herein to prevent excessive wobble. One alternate is to attach regular hard flat type rollers on to the flywheel. Rollers to ride on an outside sleeves for the flywheels, mounted as per above sleeve tough. (See FIG. 8).

Another alternate from above is the arrangement of simple sleeves of thin sheets mounted as per the previously mentioned sleeve trough. The sleeve would be positioned just on the outside of the flywheels. The outside edge of the flywheels would have Teflon (Trademark), Nylon (Trademark) or other oil impregnated skid knobs mounted. A very slight gap is to be provided. An occasional rub is expected. (See FIG. 21)

With regard to the additive aspect of the gyroscopic motion machine, several embodiments are provided within the scope of the device. First, rows of gyro pairs can be added for the same gyro assembly, providing multi-row units. This arrangement adds power to the reaction force or push. Different arrangements are possible. The first option is a lined up arrangement with all CCW gyro flywheels at 0 degrees and all CW gyro flywheels at 180 degrees initially. (See FIG. 1)

In a second option, a staggered arrangement is provided. It must be done in particular order. For a four pair unit, the flywheels must be arranged in an angular order, starting with 0 degrees, then add 45 degrees then 90 then 135 degrees. These flywheels would have a CW rotation. Then the flywheels starting with 180, then 225, then 270 and 315 degrees are to have CCW rotation. This would allow a pair at the sets (0, 180) on one row and likewise (45, 225), (90, 270) and (135, 315). The rotation motion is smoother, since the gyros are arranged around the circumference. Many more rows are possible. Also dynamic balanced assembly wheel units are smoother and easier for longer bearing endurance. (FIG. 1 shows a 0 and 180 degree line up arrangement, but the above is not shown.)

As per the second option above having a staggered arrangement, a similar arrangement is a much larger assembly wheel with more spacing to allow all the gyro flywheels and motor to be arranged in the staggered positions. The same pair arrangement as per above is to be utilized, maintaining the proper order and rotation. (See FIG. 3)

For single pair ground units only, additional weight matching the flywheels and motors could be added on each assembly at 90 degree opposites, such as for gyro pairs at 0 degrees and 180 degrees, and weights could be added at 90 degrees and 270 degrees. This would make the rotation smoother with much less tendency to get out of balance, and the bearings, etc. would have longer endurance. (See FIG. 32)

The additive aspect of adding assembly rows could be accomplished by a component design for both ground units and VTOL units. However, there are some slight differences for the row assembly components of the VTOL unit, due to the light weight design requirements and the mounting arrangement. (See FIG. 33)

Various accessories are designed to enhance or extend the operation of the gyroscopic motion machine for purposes such as flight. For example, a ballast system is provided for aircraft that includes use of gyro assembly movement and weight movements for balancing. Such ballast weight may comprise of liquid or solid weight material for ballast adjustments. In particular, a water based ballast system would utilize piping, control valves, pumps and storage tanks. (A water ballast system is included and shown.) Alternately, solid weights could be moved by provision of motorized gears and tracks or cables with motorized reels. (These are not shown.) Gyro assemblies could be moved likewise. (Gyro movement systems are included and shown. See FIGS. 22, 23, 24, 31 and 36) These configurations use fifth, sixth, seventh and eighth motors. Some combination and arrangement of the mentioned accessories would be required to allow level flight without tilting over. (See FIGS. 15, 16, and 17.) In addition a swivel mounted system for the vertical lift gyro unit is included. (See FIGS. 18.)

Some gyro assemblies could be increased in speed for increased lift. A typical air craft would utilize four gyro assemblies for vertical lift, one on each corner. It would also contain one for horizontal motion gyro assembly, and one smaller horizontal gyro assembly for stability. (See FIGS. 14 and 15) The vertical direction force of each vertical lift gyro assembly will be maintained with a swivel joint and four spring-mounts. The small vertical water storage tank will keep the vertical lift assembly in the vertical position. The arrangement will allow each gyro assembly unit to swivel and maintain a vertical direction even when the craft may be tilted. This will eliminate a quick tilting problem for much better flight control. This is to work in conjunction with the VFD Central Controllers. This would also allow better embankment for turning, by keeping the reaction forces completely vertical at all times. (See FIG. 18)

In lieu of gears or pulleys for the gyro assembly drive, a rubber friction wheel could be used, similar to a shift on the fly drive system used on some lawn mowers. A motorized or energized rubber friction wheel with spring pressure would ride on the disk surface. It could be moved in or out manually for speed control for a shift on the fly by operating in connection with the third motor. (See FIG. 28) This design does not allow for a shift on the fly but merely provides a constant speed drive that is manually adjustable during a shut down. A shift on the fly mechanism would be an obvious improvement. A similar and more powerful drive system which utilizes the rubber friction wheel is included. It has a stand mounting frame for the motor swivel mechanism. The design allows the swivel motion with the pressure applied for friction, etc. (See FIG. 38.)

It is contemplated that the gyroscopic motion machine disclosed will be used in future propulsion system. An exemplary propulsion system uses the machine on solar powered crafts for deep space travel; the unlimited power supply would allow a continual force being applied to the craft. Therefore, the craft would continue to accelerate with no air resistance for extremely high speed travel. This unit would not have any exhaust discharge and would not require rocket fuel, as a pure reaction force for motion is utilized. The solar panels could be the photo-electric type with chemical storage batteries. The batteries would be the best available for continually use. Even a steam & condensate type solar panel system could be utilized for a system with no batteries.

1. A gyroscopic motion machine comprising:
a. at least one flywheel pair comprising at least one first flywheel positioned 180 degrees diametrically opposed to at least one second flywheel;
b. at least one motor, said flywheel pair being directly coupled to the motor for rotationally driving the flywheel pair, and said motor drives said first flywheel counterclockwise and drives said second flywheel clockwise;
c. at least one assembly wheel component in which the flywheel pair is mounted within the assembly wheel component and the flywheels of the flywheel pair rotate inside of the assembly wheel component on at least one shaft within the assembly wheel component;
d. an assembly wheel unit formed by one or more of the assembly wheel components;
e. a power source arranged to deliver power to the motor coupled to each flywheel; and
f. a drive motor connected to the assembly wheel unit for rotation of the assembly wheel unit.

2. A gyroscopic motion machine as in claim 1 in which said assembly wheel component includes a disk component having a pair of parallel spaced disks defining a space in which said flywheel pair is mounted in the space between the spaced disks.

3. A gyroscopic motion machine as in claim 1 in which said power source comprises batteries mounted inside of the assembly wheel component.

4. A gyroscopic motion machine as in claim 1 in which said at least one motor includes a separate motor coupled to each flywheel of said at least one flywheel pair.

5. A gyroscopic motion machine as in claim 4 in which each of said motors comprise an engine and said power source is a fuel tank mounted inside of the assembly wheel component.

6. A gyroscopic motion machine as in claim 1 comprising multiple assembly wheel components stacked in a row within the assembly wheel unit and the multiple assembly wheel components are connected and rotated by the drive motor.

7. A gyroscopic motion machine as in claim 1 in which each assembly wheel component comprises multiple flywheel pairs with each pair being equally spaced and each pair including a first flywheel positioned 180 degrees diametrically opposed to a second flywheel

8. A gyroscopic motion machine as in claim 7 in which each flywheel pair is symmetrical and the flywheel pairs of the assembly wheel components are aligned in multiple straight line rows within the assembly wheel unit.

9. A gyroscopic motion machine as in claim 7 in which each flywheel pair is symmetrical and the flywheel pairs are equally spaced in equidistant angular displacement with respect to each flywheel pair within the assembly component.

10. A gyroscopic motion machine as in claim 1 comprising bearing members added to the outside edge of each flywheel and said bearing members engage the outside edge of the flywheels, whereby the bearing members stabilize the flywheels to prevent wobble.

11. A gyroscopic motion machine as in claim 10 in which said assembly wheel unit is mounted to a swivel and said drive motor unit includes a reversing motor connected to the assembly wheel unit.

12. A gyroscopic motion machine as in claim 1 in which said motor comprises a single electric motor that is mounted within the assembly wheel component for each flywheel pair and said motor is coupled to the flywheel pair for counterclockwise rotation of said first flywheel and clockwise rotation of said second flywheel.

13. A gyroscopic motion machine as in claim 1 in which said motor comprises a hydraulic drive system for each flywheel pair mounted within said assembly wheel component.

14. A gyroscopic motion machine as in claim 1 in which each said flywheel comprises a rim with weights attached about a perimeter of the rim.

15. A gyroscopic motion machine as in claim 1 in which each said flywheel comprises a spoke rim wheel with weights attached about a perimeter of the spoke rim wheel.

16. A gyroscopic motion machine as in claim 1 in which each said flywheel comprises a hub with multiple line extending from the hub and spherical weights attached to the each line on a distal end from the hub.

17. A gyroscopic motion machine as in claim 2 in which the drive motor is coupled to a pair of rubber drive wheels and the rubber drive wheels engage one of the disks of the disk component by spring pressure.

18. A gyroscopic motion machine as in claim 2 in which the drive motor is coupled to drive a rubber drive wheel by a pulley system having a small pulley, a large pulley and a connecting belt, an solenoid motor is connected to the rubber drive wheel, the drive motor is further connected to a slide joint and the slide joint is attached to a lever and shaft, and said lever is attached to said rubber drive wheel.

19. A gyroscopic motion machine as in claim 1 further comprising a variable radius gyro flywheel positioning system including a shaft for movement of the flywheels of a flywheel pair for adjustment distance between the flywheels.

20. A gyroscopic motion machine as in claim 2 further comprising additional weights mounted on the disk component at 90 and 270 degrees, wherein the first flywheel is relatively positioned at 0 degrees, whereby the weights are positioned at a 90 degree rotational offset from the flywheel locations of the flywheel pair.
